(19) United States
(12) Patent Application Publication
(10) Pub. No.: US 2026/0015816 A1
(43) Pub. Date: Jan. 15, 2026

(54) MACHINE GUIDANCE SYSTEM FOR TERRAIN DETECTION AND/OR AUTONOMOUS EXCAVATION USING A CONSTRUCTION ASSET

(71) Applicant: EQUIPMENTSHARE.COM INC, Columbia, MO (US)

(72) Inventors: James Dianics, San Diego, CA (US); Shane Trimble, Dublin (IE); Seth Kasmann, Columbia, MO (US); David Pasley, Topeka, KS (US); Rob Martin, Columbia, MO (US); Sheila Bagley, Columbia, MO (US)

(21) Appl. No.: 19/268,778

(22) Filed: Jul. 14, 2025

Related U.S. Application Data
(60) Provisional application No. 63/671,519, filed on Jul. 15, 2024.

(51) Int. Cl. E02F 3/43; E02F 9/20; G05D 1/242; G05D 1/245; G05D 1/246; G05D 1/248; G05D 1/622; G05D 1/689; G05D 105/05; G06V 10/44; G06V 10/77; G06V 10/80; G06V 20/58

(52) U.S. Cl. CPC E02F 3/431; E02F 9/2045; G05D 1/242; G05D 1/245; G05D 1/2464; G05D 1/248; G05D 1/622; G05D 1/689; G06V 10/443; G06V 10/7715; G06V 10/806; G06V 20/58; G05D 2105/05

(57) ABSTRACT

A machine guidance system and method utilize optical sensors, position sensors, and movement sensors to generate point cloud data for a construction asset. Data encompassing terrain features, obstacles, and the real-world position and orientation of the asset and its attachment are calculated. The fused data is used to autonomously control the movement of the asset and the position of the attachment to maintain a cutting edge at a target grade. As a result, terrain mapping and obstacle detection are performed in real-time, enabling safe and efficient operation without predefined paths. In this manner, applications include automated earthmoving, grading, and material handling in dynamic construction environments.

### CROSS-REFERENCE TO RELATED APPLICATIONS

This application claims priority to U.S. Provisional Application No. 63/671,519 (filed 15 Jul. 2024). This application is related to U.S. Patent Application Nos. XX/XXX,XXX (Docket Nos. EQS-003US1 and 661-0103US1); YY/YYY,YYY (Docket Nos. EQS-003US2 and 661-0103US2); and ZZ/ZZZ,ZZZ (Docket Nos. EQS-003US3 and 661-0103US3) (filed concurrently with this application). The entire disclosures of these applications are incorporated herein by reference.

### TECHNICAL FIELD

The inventive subject matter described herein relates to asset automation and machine guidance, and more particularly to systems and methods for real-time terrain detection, mapping, and autonomous excavation using sensor fusion and advanced data processing on assets such as construction vehicles. The technology enables automated earthmoving, grading, and material handling by integrating terrain modeling, obstacle identification, and autonomous control of vehicle attachments in dynamic construction environments.

### BACKGROUND

Construction vehicles play an important role in modern construction, where heavy machinery such as loaders, excavators, and dozers are routinely employed for earthmoving and material handling. Construction and related fields of work involve different tasks that are performed by different types of construction vehicles. Typical construction vehicles include loaders, excavators, compactors, and other earthmoving vehicles, any combination of which may be used at a work site. These vehicles incorporate various moveable components that are necessary for performing a range of tasks. For example, some construction vehicles have arms, appendages, attachments, or other moveable parts that can be manipulated during operation of the vehicle. For example, a loader includes a main body connected to a lift arm that can be raised and lowered, which in turn is connected to one of various attachments (such as a bucket attachment, a mower attachment, etc.).

In recent years, efforts have increased to integrate advanced sensing technologies and guidance systems into these machines. These systems are designed to improve operational efficiency and safety by providing real-time positional and orientation information to operators, which can support tasks such as attachment manipulation and grade control. The field of vehicle guidance continues to evolve as manufacturers and researchers seek to improve the integration of data from multiple sensors to offer more comprehensive support during machine operation.

A primary objective of guidance systems in this sector is to provide accurate, real-time information that facilitates precise control over machine movements and interactions with the surrounding environment. Modern construction operations demand tools that can help operators maintain desired work parameters, such as consistent grade and alignment, while also managing complex site conditions. Such systems work to combine data from various sensors to generate actionable feedback that improves productivity, reduces operator workload, and enhances jobsite safety.

Despite considerable progress, many conventional guidance solutions encounter significant challenges within harsh construction environments. Traditional systems often depend on wired components that are vulnerable to damage from vibration, dust, and adverse weather conditions. These vulnerabilities can lead to intermittent sensor failures and reduced measurement accuracy. In addition, systems that rely on disparate sensor data frequently struggle with issues related to calibration, synchronization, and data fusion, all of which can compromise the overall reliability of the positional information. As a result, operators may face inconsistent feedback about machine movements and environmental factors, hindering the ability to maintain precise control under dynamic worksite conditions.

Operators have also experienced difficulties in managing the complexities associated with rapidly changing construction environments and varied attachment configurations. Many guidance systems do not adequately address the need for simultaneous monitoring of vehicle dynamics and real-time terrain conditions. This shortcoming can result in limited situational awareness, where critical information regarding obstacles and uneven surfaces is either delayed or inaccurate. Moreover, traditional approaches frequently require manual calibration or intervention when switching between different attachments or when environmental conditions change, which can lead to operational inefficiencies. These challenges highlight the importance of more robust, adaptable guidance solutions that can reliably integrate multiple data sources and provide precise control feedback, thereby supporting safer and more efficient construction operations.

Autonomous excavation systems further enhance the capabilities of construction vehicles by enabling them to perform tasks such as trenching, grading, and material removal with minimal operator intervention. These systems rely on precise terrain mapping and real-time sensor data to dynamically adjust the position and orientation of attachments, such as buckets or blades, to maintain alignment with the desired excavation parameters. Autonomous excavation not only reduces operator workload but also ensures consistent results, even in challenging conditions. Despite these advantages, conventional systems often face limitations in adapting to rapidly changing terrain or handling complex excavation profiles.

One challenge in terrain detection and autonomous excavation is in the integration of multiple sensors. Systems that rely on disparate sensor data frequently encounter issues related to synchronization, calibration, and data fusion, which can compromise the accuracy of terrain maps and excavation operations. For example, LiDAR sensors may provide detailed point cloud data, but inaccuracies in pitch, roll, or yaw calibration can lead to skewed terrain representations. Similarly, GPS systems may struggle to maintain precision in environments with limited satellite visibility, such as indoor or subterranean construction sites.

Another challenge is the ability to differentiate between terrain features and obstacles in real time. Construction sites often contain a mix of static terrain elements, such as slopes and embankments, and dynamic obstacles, such as equipment, personnel, or vehicles. Effective terrain detection systems must be able to classify and filter these elements to provide actionable guidance for autonomous excavation systems. Traditional systems often lack the computational power or algorithms necessary to perform this classification accurately, leading to reduced situational awareness and increased risk of errors.

### BRIEF SUMMARY OF THE DISCLOSURE

In one example, a method for autonomously performing excavation and material dumping at a worksite using a machine guidance system onboard a construction asset. The method includes receiving point cloud data from one or more than one optical sensor mounted on the asset. The point cloud data represents portions of terrain and obstacles outside of the asset. The method also includes filtering the point cloud data that is received based on one or more predetermined thresholds and applying one or more spatial filters to isolate features of the terrain from the point cloud data that is filtered, processing the point cloud data that is filtered to identify terrain features and obstacles, autonomously controlling movement of the asset and an attachment to the asset using the terrain features and the obstacles that are identified, receiving position data and movement data from one or more than one position or movement sensor mounted to the asset, fusing the point cloud data that is filtered, the position data, and the movement data to calculate a real-world position, orientation, and a calculated position of a cutting edge of the attachment, and autonomously controlling the asset to adjust the position and the orientation of the attachment to maintain the calculated position of the cutting edge of the attachment at a target grade during at least some of the movement of the asset that is autonomously controlled.

In another example, a machine guidance system for a construction asset is provided. The machine guidance system includes one or more than one optical sensor mounted on the asset. The one or more than one optical sensor senses an area around the asset and outputting point cloud data representative of portions of terrain and obstacles outside of the asset. The system also includes one or more than one position sensor mounted on the asset and configured to output position data indicative of geographic positions of the one or more than one position sensor. The system includes a movement sensor mounted on the asset and configured to output movement data indicative of movement of the movement sensor. The system includes a processing unit configured to receive and filter the point cloud data that is received based on one or more predetermined thresholds and by applying one or more spatial filters to isolate features of the terrain from the point cloud data that is filtered. The processing unit examines the point cloud data that is filtered to identify terrain features and obstacles and autonomously controls movement of the asset and an attachment to the asset using the terrain features and the obstacles that are identified. The processing unit is configured to fuse the point cloud data that is filtered, the position data, and the movement data to calculate a real-world position, orientation, and a calculated position of a cutting edge of an attachment to the asset. The processing unit is configured to autonomously control the asset to adjust the position and the orientation of the attachment to maintain the calculated position of a cutting edge of the attachment at a target grade during at least some of the movement of the asset that is autonomously controlled.

In another example, a method is provided that includes identifying an excavation location where a construction asset is to excavate material using an attachment to the asset, identifying a pile location where the construction asset is to pile the material that is excavated, obtaining point cloud data from light detection and ranging (LiDAR) sensors onboard the asset, processing the point cloud data to identify terrain features and obstacles outside of the asset, and to calculate a position of a cutting edge of the attachment, and autonomously controlling the asset to excavate the material at the excavation location using the position of the cutting edge of the attachment that is calculated, to move the asset to the pile location without colliding with the obstacles and without a previously defined or calculated path between the excavation location and the pile location being obtained, and to dump the material at the pile location using the point cloud data.

### BRIEF DESCRIPTION OF THE DRAWINGS

A detailed description of various embodiments of a machine guidance system deployed on a construction vehicle is provided below with reference to the following drawings, in which:

FIG. 1 illustrates one example embodiment of a machine guidance system;

FIG. 2 illustrates a flowchart of one example of a method for tracking a moveable part of an asset in relation to the surrounding terrain;

FIG. 3 is a perspective view of one example of the machine guidance system shown in FIG. 1 onboard an asset;

FIG. 4 is a top plan view of the machine guidance system and the asset shown in FIG. 3;

FIG. 5 illustrates a perspective view of a machine guidance assembly;

FIG. 6 illustrates a flowchart of one example of an initialization process;

FIG. 7 illustrates a flowchart of one example of the manufactured condition process;

FIG. 8 illustrates a flowchart of one example of an arm/attachment detection process;

FIG. 9 shows an example mower attachment with attachment reflectors placed thereon;

FIGS. 10A and 10B illustrate a flowchart of one example of a terrain detection process;

FIG. 11 illustrates a flowchart of one example of an internal grid update process;

FIG. 12 illustrates a flowchart of one example of a map update process;

FIG. 13 illustrates a flowchart of one example of a vehicle observer process;

FIG. 14 shows a top view of the asset and surrounding terrain, along with a side view showing the elevation of the cutting edge of the attachment in relation to the elevation of the surrounding terrain;

FIG. 15 shows a perspective view of the asset and surrounding terrain, along with a side view showing the elevation of the cutting edge of the attachment in relation to the elevation of the surrounding terrain; and

FIG. 16 is an enlarged side view showing the elevation of the cutting edge of the attachment in relation to the elevation of the surrounding terrain.

### DETAILED DESCRIPTION OF EMBODIMENTS

The following detailed description provides various embodiments of a machine guidance system and method for tracking construction vehicles and their surrounding terrain. The described technology is directed toward improving the operation, guidance, and terrain mapping capabilities of construction vehicles, such as loaders, excavators, and other heavy machinery. By integrating advanced sensor technologies, data fusion techniques, and user interfaces, the described system enhances the precision, safety, and efficiency of construction operations.

The embodiments disclosed herein are intended to encompass a wide range of modifications, substitutions, and rearrangements that would be apparent to those skilled in the art. Such variations are considered to fall within the scope of the disclosed subject matter. For example, the described calibration and setup techniques may be adapted for use with different types of construction vehicles, sensor suites, or attachment geometries, and may be implemented using alternative hardware, software, or user interface configurations without departing from the spirit of the invention. Certain well-known elements, steps, or techniques may be omitted or described in less detail to avoid obscuring the underlying concepts. The specific features and sequences described in the following embodiments should not be construed as limiting, but rather as representative of the broader inventive concepts presented.

While various examples of a machine guidance system deployed on a construction vehicle are described herein, not all embodiments of the inventive subject matter are limited to the specific configuration or methodologies of any of these embodiments unless explicitly recited or stated. Additionally, although the examples are described as embodying several different inventive features, any one of these features could be implemented without the others and that the inventive subject is not limited to any particular combination of features unless explicitly recited or stated.

The construction industry depends extensively on vehicles such as loaders, excavators, and dozers to carry out a variety of tasks, including earthmoving, grading, and material handling. These vehicles often incorporate moveable components, such as lift arms and attachments, which demand precise control and monitoring to maintain operational efficiency and safety. Traditional machine guidance systems, while providing some degree of assistance, face notable challenges. Many utilize wired components, which can be susceptible to failure in demanding construction environments characterized by vibration, dust, and debris. Moreover, these systems frequently struggle to adapt seamlessly to different attachments, necessitating time-consuming recalibration or manual adjustments when switching between tools. Additionally, conventional systems generally emphasize providing positional data for the vehicle or its attachments but often overlook the surrounding terrain or obstacles, limiting operators' situational awareness and increasing the likelihood of errors or accidents.

The described technology addresses these shortcomings by introducing an advanced machine guidance system that integrates multiple sensing technologies, data fusion algorithms, and real-time terrain mapping capabilities. A combination of optical sensors (e.g., LiDAR), location sensors (e.g., GNSS antennas and receivers), and movement sensors (e.g., inertial measurement units (IMUs)) is used to track the position and orientation of moveable parts of a construction vehicle with high precision. Unlike some known systems, the described technology eliminates the need for vulnerable wired components by utilizing passive reflectors on the vehicle's attachments, which reflect light pulses emitted by the optical sensors. This design enhances durability and simplifies the process of switching attachments, as the machine guidance system can be efficiently recalibrated by placing reflectors on new tools and performing reduced setup steps.

The system further distinguishes itself through the capability to generate real-time terrain maps and identify obstacles in the vehicle's environment. By fusing point cloud data from the optical sensors with location and movement data, the processing unit creates a comprehensive spatial model that incorporates both the vehicle's position and the surrounding terrain. Advanced filtering techniques, such as box filters and reflectivity-based thresholds, can be used to ensure that the system remains robust even in dusty or debris-filled environments. The terrain mapping functionality enables operators to visualize the vehicle's position in relation to the terrain and obstacles, enhancing situational awareness and supporting safer, more efficient operations. Additionally, the modular architecture of the system allows deployment across a wide range of construction vehicles, including loaders and excavators, and supports both manual and autonomous operation modes.

In summary, the inventive machine guidance system overcomes the limitations of traditional approaches by combining durable hardware configurations, advanced sensor fusion, and real-time environmental awareness. This integrated solution not only enhances the precision and reliability of vehicle guidance but also provides operators with actionable insights into their surroundings, enabling safer and more efficient construction workflows.

The subject matter described herein relates to machine guidance systems deployed on assets such as construction vehicles. In some examples, the machine guidance system is used to track one or more than one moveable part of the asset and generate guidance information to assist in operation of the asset. In some embodiments, the machine guidance system or method is also used to generate a map of an area of terrain surrounding the asset and generate terrain mapping information to enable display of the asset in relation to the surrounding terrain. A variety of different types of assets may be operated using the machine guidance system, such as loaders (for example, track loaders), excavators, compactors, backhoes, dozers, etc. Other types of assets that may be operated using the machine guidance system will be apparent to one of ordinary skill in the art.

The assets may be manually operated, autonomously operated, semi-autonomously operated, or may alternate between autonomous operation mode and manual operation mode. The guidance and/or terrain mapping information is provided to an operator of the asset via a human machine interface (HMI) as part of the guidance system. The guidance and/or terrain mapping information can be provided to a control system that is deployed within the asset or that is remote from the asset. This can allow for the asset to be remotely monitored and/or controlled from afar.

### I. Machine Guidance System

The machine guidance system disclosed herein may be deployed on a variety of different types of assets. The machine guidance system includes a processing unit configured to process sensor data provided by a sensor suite. The processing unit uses the processed sensor data to track the position of one or more than one moveable part of an asset. The processing unit can generate a map of an area of terrain surrounding the asset.

The sensor suite may include one or more than one sensor, such as an optical sensor detecting and tracking one or more than one moveable parts of the asset. The sensor suite can include a position sensor such as a global navigation satellite system (GNSS) receiver (e.g., a global positioning system (GPS) navigation system) for determining the position of a GNSS antenna mounted on the asset. The sensor suite can include a movement sensor that determines acceleration (e.g., linear acceleration), angular velocity, and/or magnetic heading or indications of orientation. One example of such a sensor is an inertial measurement unit (IMU) sensor for providing data relating to the rotation of the asset. The sensor suite can include a single sensor or multiple sensors. With respect to multiple sensors, the sensor suite can include at least one of each of two or more different sensors, or may include multiple sensors but less than all of the sensors described herein.

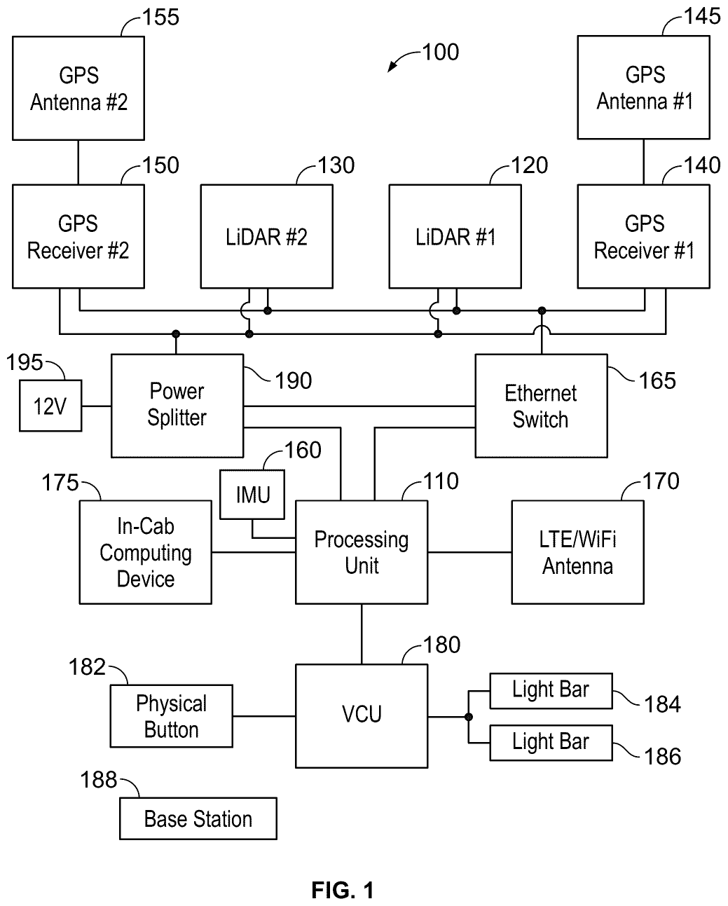

FIG. 1 illustrates one example embodiment of a machine guidance system 100. The machine guidance system 100 includes a processing unit 110. The processing unit 110 represents hardware circuitry that includes and/or is connected with one or more than one processors (e.g., integrated circuits, application-specific integrated circuits, field programmable gate arrays, graphics processing units, etc.) that perform the operations described in connection with the processing unit 110. If the processing unit 110 includes multiple processors, then the actions or operations performed by the processing unit 110 may be performed by each of the processors, or different processors may perform different actions or operations.

a. Optical Sensors

The machine guidance system 100 also includes one or more than one optical sensor 120, 130. The optical sensors 120, 130 track moveable parts, map terrain, and/or detect obstacles. These optical sensors 120, 130 can incudes LiDAR sensors, but in some embodiments can include stereo cameras, monocular cameras, time-of-flight (ToF) cameras, infrared (IR) sensors, radar sensors, or the like. The machine guidance system 100 includes one or more than one position sensors such as Global Navigation Satellite System (GNSS) receivers 140, 150 each respectively connected to a GNSS antenna 145, 155. The machine guidance system 100 includes a movement sensor 160, such as an inertial measurement unit (IMU) sensor. The movement sensor 160 may be included or onboard the processing unit 110, or may be separate from (but communicate with) the processing unit 110. The machine guidance system 100 in some embodiments includes a communication network device 165 that serves as a switch or connection between multiple computing devices. One example of such a network device 165 includes an Ethernet switch. The guidance system 100 can include a communication device 170 (e.g., a cellular or WiFi antenna), an onboard computing device 175, a vehicle control unit (VCU) 180 connected to an input device 182 and output devices 184, 186, and a power splitter 190 connected to a power adapter 195. The VCU 180 optionally can be referred to as an asset control unit (ACU) 180. The asset on which the machine guidance system 100 is deployed may be manufactured with these components, or one or more of these components may be later added to the asset (e.g., via upfitting). The output devices 184, 186 can be used to provide guidance information to the operator visually, audibly, tacitly and/or otherwise during operation of the asset. The aforementioned components may be separate components, or two or more (or all) of these components may be included in a single device.

The optical sensors 120, 130 are mounted at different locations on the asset. In some embodiments, a single optical sensor 120 or 130 may be used, or more than two optical sensors 120, 130 may be used. One optical sensor 120 or 130 may be used to reduce the overall production cost of the machine guidance system 100, while three or more optical sensors 120, 130 may be used to provide redundancy. For example, a third or fourth (or more) optical sensor 120 and/or 130 may be included in the machine guidance system 100. If an optical sensor 120 or 130 fails, then the third or fourth (or other) optical sensor may be used in place of the failed optical sensor 120 or 130. As another example, data may be received from each of the three or more optical sensors 120, 130 and used for redundancy purposes. Two optical sensors 120, 130 are used in the illustrated example to provide a continuous 360 degree view around the asset (without the asset having to turn or rotate to provide the 360 degree view).

Each of the optical sensors 120, 130 can generate optical data representative of objects (or the absence of objects) within fields of view of the optical sensors 120, 130. With respect to LiDAR sensors, the optical sensors 120, 130 generate point cloud data based on light pulses emitted and reflected back from moveable parts of the asset. For example, the asset may include reflective surfaces or reflective objects (e.g., stickers, panels, etc.) may be affixed to the moveable parts of the asset. For example, if the construction vehicle is a loader, a reflector may be placed on the lift arm of the loader and a reflector may be placed on an attachment attached to the lift arm of the loader. The reflectors may be passive devices that reflect light back to the optical sensors 120, 130. For example, the reflectors may be retroreflectors that are not powered, and do not require power (electrical or otherwise), to operate. The reflectors may not be wired or otherwise conductively coupled with any power source. The reflectors may be tape, sheeting or other material with a reflective surface that is suitable for reflecting light back to a LiD AR sensor, such as the white aluminum foil tape. However, other optical sensors 120, 130 may be used, and other reflectors or no reflectors may be used.

The non-wired reflective surfaces (e.g., tape or plates) placed on moveable parts of the asset eliminates vulnerabilities or failure points associated with wired systems, such as damage from vibration, dust, or debris. This can help the machine guidance system 100 operate in harsh construction environments. In general, a harsh construction environment is a worksite characterized by challenging or extreme physical conditions that can impact the safety of workers, the durability of materials, and the overall progress and success of the project.

b. Asset Control Unit (ACU)

The ACU 180 or the processing unit 110 actively controls or limits the movement of the asset based on obstacle detection and terrain mapping to ensure safe and efficient operation. The ACU 180 represents the central processing and control module of the asset. The ACU 180 represents hardware circuitry that includes and/or is connected with one or more processors (e.g., one or more integrated circuits, application-specific integrated circuits, field programmable gate arrays, etc.) that perform the operations described herein in connection with the ACU 180. The processing unit 110 communicates with the ACU 180 of the asset. The asset control unit 180 is the central processing and control system integrated into the asset. The asset control unit 180 serves as the primary interface between the hardware components of the asset (e.g., sensors, actuators, and attachments) and the operator. The asset control unit 180 in some embodiments can autonomously or semi-autonomously control operation of the asset based on data and signals provided by the processing unit 110.

The ACU 180 receives input from the operator via the input device 182 and/or from the processing unit 110, with this input directing changes in movement of the asset, positions of arms of the asset, and/or positions/orientations of the attachment. For example, the ACU 180 can control cylinders, motors, engines, or the like, to move the asset, asset arms, and/or asset attachment based on input from the processing unit 110 and/or operator (e.g., through the input device 182).

Actuators, such as hydraulic cylinders, pneumatic cylinders, electric motors, or the like, onboard the asset are controlled by the processing unit 110 and/or ACU 180 adjust the tilt and/or position of the attachment to align the attachment (e.g., the cutting edge of a bucket) with the calculated slope and/or cross-slope parameters. The processing unit 110 and/or ACU 180 can modify the moving speed and trajectory of the asset to maintain consistent operation of the attachment along the slope and cross-slope.

Using real-time data from the optical sensors 120, 130, location sensors, and/or the movement sensor 160, the processing unit 110 identifies obstacles and differentiates the obstacles from terrain features while the asset is moving and/or stationary. If an obstacle is detected within the planned path of movement of the asset or within a threshold distance of the asset, the processing unit 110 or the ACU 180 can calculate an alternative route or stop the movement, or alert the operator of proximity to an obstacle, to prevent collisions and/or generate an alert to warn the operator (e.g., using sound generated via a speaker, flashes on the output devices 184, 186, or the like). Similarly, the terrain mapping data is analyzed to identify hazardous conditions, such as steep slopes, uneven surfaces, or unstable ground. The ACU 180 or processing unit 110 uses this information to dynamically adjust the speed, direction, and attachment positions of the asset. For example, the ACU 180 may limit the speed of the asset when approaching a steep incline or prevent the bucket or blade attachment from moving beyond a safe range of motion when operating near an obstacle. By integrating obstacle detection and terrain mapping with the ACU 180 or processing unit 110, the ACU 180 or processing unit 110 ensures that the asset operates within safe parameters, reducing the risk of accidents and improving overall operational efficiency.

c. Location Sensors

The location sensors (e.g., the GNSS antennas 145, 155 and associated receivers 140, 150) can be mounted at different locations on the asset. Each of the GNSS antennas 145, 155 receives and, in some embodiments, amplifies signals transmitted or broadcast by GNSS satellites and converts the signals for use by the GNSS receivers 140, 150. The GNSS receivers 140, 150 analyze the received signals to determine the positions of the GNSS antennas 145, 155. In one example, one GNSS antenna 145 serves as a system reference point for the machine guidance system 100, and another GNSS antenna 155 is used to determine heading and/or pitch of the asset. The GNSS receivers 140, 150 use real-time kinematics (RTK) positioning technology to provide more precise position information in one example.

The machine guidance system 100 may include two GNSS antennas 145, 155 mounted on the asset or may include more than two GNSS antennas 145, 155. The GNSS antennas 145, 155 and GNSS receivers 140, 150 work together to provide precise positional, heading, and pitch information for the asset. The GNSS antennas 145, 155 can be placed on the asset to serve distinct but complementary purposes. One GNSS antenna 145 can be placed closer to a front or leading edge of the asset and operate as the primary reference point for the machine guidance system 100. The signals received by this front GNSS antenna 145 are examined by the GNSS receiver 140 to provide the absolute position of the asset (e.g., in a global coordinate system, such as latitude, longitude, and altitude. This GNSS antenna 145 serves as the fixed reference for calculating heading and pitch when combined with data from the rear GNSS antenna 155. The front GNSS antenna 145 can be mounted on a stable, fixed part of the asset, typically near the front or center of the body of the asset.

The other GNSS antenna 155 can be mounted on the asset farther from the front than the front GNSS antenna 145 (and closer to the opposite back of the asset than the front GNSS antenna 145). The rear GNSS antenna 155 can be mounted on a moveable or rear part of the asset, such as the rear linkage or a stable rear section of the asset. The rear GNSS antenna 155 works with the front GNSS antenna 145 to calculate heading and pitch of the asset. The rear GNSS antenna 155 measures the relative position of the rear of the asset compared to the front. The rear GNSS antenna 155 provides signals to the GNSS receiver 150, which uses the signals to calculate the heading (e.g., the direction of travel) of the asset by calculating the angle between the two GNSS antennas 145, 155. The GNSS receiver 150 also can calculate the pitch of the asset (e.g., the tilt of the asset along its longitudinal axis) by comparing the vertical displacement between the two GNSS antennas 145, 155.

In some embodiments, the machine guidance system 100 does not include the GNSS receivers 140, 150 and/or antennas 145, 155. In these embodiments, the machine guidance system 100 uses other techniques to determine the real-world geographic position of the asset. For example, the machine guidance system 100 can include one or more than one reflector positioned at a known location. The optical sensor 120 and/or the optical sensor 130 generate point cloud data based on the light pulses emitted and reflected back from that reflector to determine the position of the optical sensor 120 and/or the optical sensor 130 and, therefore, the location of the asset relative to the reflector. Because the reflector location is known, the location of the asset relative to the reflector can then be converted into the location of the asset. In one example, the reflectors may include optical patterns, such as QR codes, or a SLAM system or algorithm may be used to determine the positions of the reflector(s).

d. Movement Sensor

The movement sensor 160 is mounted on the asset and provides data relating to movement of the asset, such as rotation of the asset. This data can be repeatedly provided by the movement sensor 160 (e.g., to the processing unit 110), such as in a continuous stream or otherwise repeated stream of data. The movement sensor 160 can output signals indicative of roll, pitch, and/or yaw rotation of the asset. The movement sensor 160 can be mounted at or close to the center of rotation of the asset, or in another location.

e. Processing Unit

The processing unit 110 receives sensor data from the sensors of the machine guidance system 100 via the network device 165. The network device 165 (e.g., an Ethernet switch) manages the flow of sensor data from the optical sensors 120, 130, the movement sensor 160, and/or the location sensors (e.g., the receivers 140, 150) to the processing unit 110. The network device 165 may be a ruggedized gigabit Ethernet switch, although other components capable of performing packet switching (e.g., in accordance with the Ethernet or Industrial Ethernet (IE) standard) may be used.

### 1. Data Fusion

The processing unit 110 fuses or otherwise combines the sensor data received from the sensors in the sensor suite (e.g., the optical sensors 120, 130, the GNSS receivers 140, 150, the GNSS antennas 145, 155, and/or the movement sensor 160). The processing unit 110 uses the fused data to track moveable parts of the asset in relation to the surrounding terrain. The processing unit 110 uses the fused data to provide guidance and/or terrain mapping information to an operator of the asset.

The GNSS receivers 140, 150 provide real-time positional data for the asset. This allows for the processing unit 110 to precisely track the location of the asset at a worksite. This is useful for tasks such as mapping the terrain, defining work boundaries, and ensuring accurate excavation or grading. The heading of the asset can be used by the processing unit 110 to maintain alignment of the asset during operations such as trenching, grading, or material placement. The pitch of the asset can be used by the processing unit 110 to maintain proper blade or bucket angles, and ensure accurate grade control. The GNSS data can be fused with data from other sensors, such as the optical sensors 120, 130 and/or the movement sensor 160, to comprehensively track the position, orientation, and movement of the asset. This fusion improves the accuracy and reliability of the machine guidance system 100, especially during operation on dynamic or uneven terrain.

Using multiple GNSS antennas 145, 155 can provide more precise heading and pitch calculations compared to a single GNSS device. The combination of absolute positioning (e.g., using the front GNSS antenna 145) and relative positioning (e.g., using the rear GNSS antenna 155) allows for terrain mapping, grade control, obstacle avoidance, and the like.

Using the data output by dual or multiple GNSS antennas 145, 155 (e.g., front and rear antennas) in combination with the data output by the optical sensors 120, 130 can provide more precise positional, heading, and pitch information for the asset when compared with other machine guidance systems. For example, a dual location sensor configuration enables real-time tracking of the orientation and movement of the asset, which can be helpful for tasks such as grade control and terrain mapping. The dual location sensor setup provides increased accuracy for heading and pitch calculations compared to machine guidance systems that rely on single location sensors, while the integration with the optical sensors 120, 130 improves terrain mapping and obstacle detection.

2. Communication with Computing Devices

The processing unit 110 interfaces with the communication device 170 for communication with an off-board computing device over one or more than one computerized communication networks (e.g., a cellular network, a WiFi network, etc. This computing device 175 can be a mobile phone, tablet computer, laptop computer, or the like, which may be used by an operator to input set-up information. The set-up information may include the type of asset and attachment to be operated with the assistance of the machine guidance system 100 and, in some embodiments, may also include one or more than one operating parameters to be used by the machine guidance system 100.

The processing unit 110 communicates with the onboard computing device 175 that can be located within the cab of the asset or on the roof of the asset. The onboard computing device 175 can be a mobile phone, a tablet computer, a laptop computer, or the like. The onboard computing device 175 may display various guidance information and maps that can be viewed by the operator during operation of the asset.

f. Input Devices and Output Devices

The processing unit 110 communicates with the asset control unit 180 of the asset. The asset control unit 180 is the central processing and control system integrated into the asset. The asset control unit 180 serves as the primary interface between the hardware components of the asset (e.g., sensors, actuators, and attachments) and the operator. The asset control unit 180 can, in some embodiments, autonomously and/or semi-autonomously control operation of the asset based on data and signals provided by the processing unit 110.

The asset control unit 180 controls actuators that adjust the position and movement of asset components, such as the position of a bucket or blade of the asset to provide proper alignment and grade control, the movement of arms of the asset, hydraulic pressures of the asset for control of the arms and attachments, and the like. The asset control unit 180 provides an operator interface and can output visual and/or audio feedback to the operator via displays, light bars, etc.

The asset control unit 180 interfaces with one or more than one input device 182 and one or more than one output device 184, 186, which may be located within the cab of the asset. The input device 182 may be a button, switch, lever, selectable icon on a graphical user interface, etc. The input device 182 can be used by the operator to input information during the set-up process. In another example, the operator may input this information using the onboard computing device 175. The output devices 184, 186 visually convey positional feedback information to the operator. For example, the output devices 184, 186 may be elongated displays or lamps (e.g., light bars) that illuminate to communicate positions of the asset, portions of the asset (e.g., arms of the skid steer loader), and/or attachments (e.g., a bucket connected to the arms). The output devices 184, 186 are elongated LED light bars used to provide guidance information to the operator during operation of the asset, as described above. During the set-up process, the output devices 184, 186 may be configured to operate in different modes, such as a standard mode, a dual mode, or a quad mode, as described herein. The onboard computing device 175 also can be an input and/or output device of the machine guidance system 100.

g. Base Station

The machine guidance system 100 also includes a base station 188. The base station 188 can be located off-board the asset, and may be a stationary component of the machine guidance system 100. For example, the base station 188 can be still while the asset moves at a worksite. The base station 188 may be moveable between different worksites (e.g., upon completion of work or usage of the machine guidance system 100 at one worksite, the base station 188 can be moved to another worksite).

The base station 188 can provide a fixed, high-accuracy reference point for the machine guidance system 100, such as for the location sensors 140, 145, 150, 155. The base station 188 can include (and/or the base station 188 shown in FIG. 1 can represent) one or more GNSS antennas (e.g., similar or identical to the antenna 145 and/or 155) and/or one or more GNSS receivers (e.g., similar or identical to the receiver 140 and/or 150). The base station 188 may include or be connected to a power supply, such as a generator, power utility grid, battery or battery cells, etc. The base station 188 can include one or more than one communication device for wirelessly communicating with the processing unit 110 of the machine guidance system 100 (e.g., via the communication device 170). The communication device of the base station 188 may be similar or identical to the communication device 170. The base station 188 can include a processing unit similar or identical to the processing unit 110 of the machine guidance system 100.

The GNSS antenna of the base station 188 receives GNSS satellite signals that are used by the GNSS receiver of the base station 188 to calculate a geographic location (e.g., longitude, latitude, and/or altitude) of the base station 188. The processing unit of the base station 188 may communicate with the processing unit 110 of the machine guidance system 100, compare locations determined by the GNSS receivers 140 and/or 150 of the machine guidance system 100 and determined by the GNSS receiver of the base station 188, and decide whether the machine guidance system 100 is within a threshold distance limit from the base station 188. For example, the processing unit 110 of the machine guidance system 100 may not permit autonomous or semi-autonomous operation of the asset, terrain mapping or updating of terrain maps, etc. if the machine guidance system 100 (and, therefore, the asset) are more than five miles from each other (as one example, although other distances may be used).

The processing unit of the base station 188 can receive a designated location (e.g., longitude, latitude, and/or altitude) from an operator of the machine guidance system 100 or from another source (e.g., output from a survey of a worksite). The processing unit of the base station 188 compares this input location and compare the input location with the location calculated using the GNSS satellite signals received by the GNSS antenna of the base station 188. The processing unit of the base station 188 can calculate a difference, or error, between these locations. A correction can be calculated based on this difference, such as values to add or subtract to the longitude, latitude, and/or altitude values calculated by the GNSS receiver of the base station 188. This correction can be communicated from the base station 188 to the processing unit 110 of the machine guidance system 100. The processing unit 110 can then apply the correction to locations calculated by the GNSS receiver(s) 140, 150 of the machine guidance system 100 to ensure that any errors in the locations determined from the GNSS satellite signals are corrected.

In another example, the base station 188 may be mobile. For example, the base station 188 may include or be on wheels, tracks, or the like, for self-propelling or being moved (manually or with the aid of the asset or another vehicle). In another example, the base station 188 may be part of or coupled to a stationary object, such as a building or another structure. As another example, one of the GNSS antennas 145, 155 can receive signals for establishing the reference location described above.

### II. Tracking Process

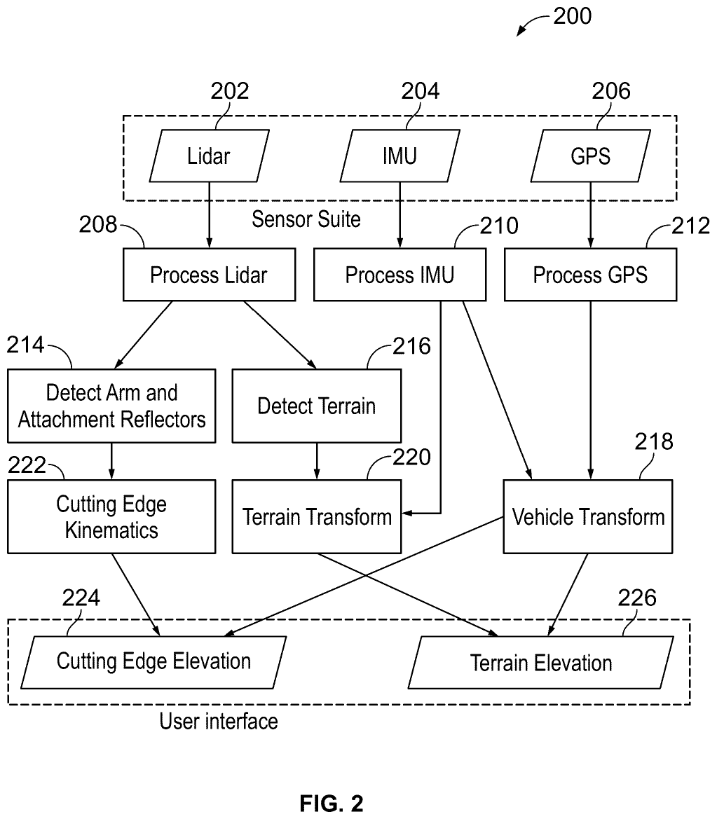

FIG. 2 illustrates a flowchart of one example of a method 200 for tracking a moveable part of an asset in relation to the surrounding terrain. While the operations of the method 200 are generally described with respect to FIG. 1, the operations may otherwise be performed. The method 200 can be used to track the cutting edge of a bucket attachment of a loader during the performance of grading (e.g., the process of shaping and leveling the ground before building). The method 200 can be used to position the cutting edge of the bucket attachment at a desired elevation relative to the elevation of the terrain. Alternatively, the method 200 may be used in connection with other assets and/or attachments to perform different tasks.

The method 200 includes parallel processing operations—for example, the sensor data collection operations 202, 204, and/or 206 can be performed in parallel or during overlapping time periods, the sensor data processing operations 208, 210, and/or 212 can be performed in parallel or during overlapping time periods, the arm/attachment reflector and terrain detection operations 214 and 216 can be performed in parallel or during overlapping time periods, the terrain and vehicle transform and cutting edge kinematics operations 222, 220, and/or 218 can be performed in parallel or during overlapping time periods, the operations 224 and 226 relating to the display of cutting edge and terrain elevations via a user interface (e.g., the onboard computing device 175 and/or light bars 184, 186) can be performed in parallel or during overlapping time periods.

a. Data Collection and Fusion

At 202, optical data related to reflectors on the asset are collected. For example, the optical sensors 120, 130 can generate point cloud data based on light pulses emitted and reflected back from a reflector placed on a lift arm of the asset and/or another reflector placed on the attachment connected to the lift arm (e.g., the bucket attached to the lift arm). At 204, movement data representative of movement of the asset is generated. For example, the movement sensor 160 can generate movement data indicative of movement of the asset. This data can include roll, pitch, and/or yaw rotation parameters for the asset. At 206, location data is obtained and used to determine positions. For example, the GNSS receivers 140, 150 can analyze electrical signals received from the GNSS antennas 145, 155, respectively, to determine the positions of the antennas 145, 155. Optionally, the location sensors use RTK positioning technology to provide more precise position information about the asset (such as accuracy of about one centimeter).

At 208, 210, and 212, data is fused and processed. For example, the processing unit 110 can process the point cloud data provided by the optical sensors 120, 130 (at 208), process the movement data provided by the movement sensor 160 (at 210), and process the position data provided by the GNSS receivers 140, 150 (at 212). In some embodiments, less than all of this data is processed. The data can be processed by receiving and fusing the different sensor data based on the timestamps associated with the sensor data. For example, point cloud data, IMU data, and GNSS data may be fused (e.g., combined or associated with each other) if the respective timestamps are within a specified tolerance of each other. As another example, one or more Kalman filters or complimentary filters can be used to fuse the data. If one of the sensors 120, 130, 160, GNSS antennas 145, 155, and/or GNSS receivers 140, 150 fails or generates data that is outside of an acceptable range of values, the processing unit 110 can fuse the data from the remaining sensors 120, 130, 160, GNSS antennas 145, 155, and/or GNSS receivers 140, 150 by replacing the data from the failed sensors 120, 130, 160, GNSS antennas 145, 155, and/or GNSS receivers 140, 150 with data from another one of the sensors 120, 130, 160, GNSS antennas 145, 155, and/or GNSS receivers 140, 150 that has not failed. For example, if a GNSS antenna 145, 155 or GNSS receiver 140, 150 fails, the processing unit 110 can use data from the movement sensor 160 to replace the movement, velocity, pitch, etc. data that otherwise may have been obtained by the failed GNSS antenna 145, 155 and/or GNSS receiver 140 and/or 150.

b. Reflector Position Calculations

At 214, the position of one or more than one reflector on part of the asset is or are determined. For example, the processing unit 110 can analyze the optical data (from 208) to detect the position of a first reflector placed on part of the arm of the asset and the position of a second reflector placed on the attachment that is connected with (and separately moveable from) the arm. The positions of the first and second reflectors may be detected, for example, by calculating the centroids of the reflectors from the optical data. As another example, the positions of the first and/or second reflectors may be identified by manually measuring the position(s) of the first and/or second reflectors.

The method 200 can include filtering data at 214. For example, the processing unit 110 can filter out data points having reflectivity or signal values below a predetermined threshold. This can make the method 200 and system 100 robust to dust in the environment. For example, the method 200 can disregard weak or low-quality signals that may result from environmental factors such as dust, fog, or other airborne particulates that can scatter or attenuate light signals. By applying this filtering mechanism, the method 200 ensures that only stronger, more reliable data points are used for tasks such as terrain mapping, obstacle detection, and tracking of moveable parts. For example, the reflectivity values of the data points may vary between a lower or minimum value and an upper or maximum value. The predetermined threshold used to filter out data points having lower reflectivity values may be 50% of the upper or maximum value, 60% of the upper or maximum value, or another percentage. This allows the method 200 to maintain accurate and consistent performance even in harsh or dusty environments commonly encountered on construction sites. The filtering process reduces noise in the data, improving the overall reliability and precision of the method 200.

As another example, the processing unit 110 (at 214) can use one or more than one box filter to filter out data points that are not associated with the reflectors (given the known positions of the reflectors in relation to the known position of the front antenna 145, which serves as a system reference point). The box filter can be a spatial filter that applies a uniform averaging operation over a defined region, or box, of data points. The processing unit 110 defines a rectangular or cubic region around a target data point in a dataset, such as a 3D point cloud, received from the optical sensor(s) 120, 130.

An operation such as averaging or summing is applied to these data points within the box to calculate an output value for the target point (e.g., the reflector in the point cloud). The size of the box (e.g., the width, height, and depth of the box) determines the range of data points included in the operation. The size of the box can be adjusted based on the specific requirements of the application, such as the density of the point cloud or the level of noise in the environment. The box filter smooths the point cloud data by averaging the values of points within the defined box. This helps to reduce random noise caused by environmental factors such as dust, debris, or sensor inaccuracies. The filter can exclude outlier points that deviate significantly from the surrounding data. For example, points with unusually high or low reflectivity values may be removed to improve the accuracy of terrain mapping and obstacle detection.

By aggregating data within the box, the filter reduces the overall complexity of the optical data (e.g., the point cloud). The box filter can be used by the processing unit 110 to isolate and enhance data points associated with reflectors placed on moveable parts of the asset. By focusing on points within a specific region, the processing unit 110 can more accurately track the position and orientation of the arm and/or attachment of the asset.

In some examples, the processing unit 110 (at 214) compares the number of filtered data points to a number of points expected to be returned by each reflector to detect one or more than one error. For example, the processing unit 110 determines that the number of filtered data points (or the average or sum of the filtered data points) indicates an error when the number, average, or sum falls below a lower threshold. The errors that can be identified by the processing unit 110 in this way can be an object blocking the view between the optical sensor 120, 130 and the reflector, the reflector falling off the asset, damage to the reflector, a dirty optical sensor 120, 130, too much dust in the environment, a foreign reflective object close to the reflector, etc. If an error is detected, the processing unit 110 can return an error message so that the operator can identify and correct the error. In one example, the processing unit 110 may prevent continued movement of the asset, the arm, and/or the attachment responsive to such an error being identified.

c. Terrain Mapping

At 216, the optical data is analyzed to detect terrain elevation around the asset and/or generate or update a terrain map showing obstacles near the asset. The processing unit 110 analyzes the point cloud data from 208 (and which may be filtered) to detect the elevation of the terrain surrounding the asset, as well as generate a terrain map that may include the presence of any obstacles near the asset.

The processing unit 110 (at 216) can segment the point cloud to separate or differentiate terrain points from non-terrain objects, such as vehicles, trees, or buildings. These operations can be performed using algorithms that classify points based on height, reflectivity, and/or clustering. For example, the processing unit 110 differentiates between obstacles and terrain features by analyzing the point cloud data generated by the optical sensors 120, 130, along with data from other sensors like the location sensors and the movement sensor 160. The processing unit 110 differentiates between obstacles and terrain features using segmentation, classification, and filtering techniques. The point cloud data represents the surrounding environment, including both terrain features (e.g., ground, slopes) and obstacles (e.g., rocks, equipment, personnel). The location data from the location sensors and the movement data from the movement sensor 160 indicate the position and orientation of the asset, which is used by the processing unit 110 to identify the relative location of detected objects.

The processing unit 110 (at 216) can preprocess the point cloud data by applying noise filter(s) and/or outlier removal (e.g., using box filters). The processing unit 110 segments the point cloud into distinct clusters or regions to isolate potential obstacles from the terrain. The processing unit 110 can use progressive morphological filtering or cloth simulation filtering to identify ground points, or points in the data cloud indicative of the terrain. This can involve the processing unit 110 analyzing the relative height of points and their spatial distribution to distinguish ground points (e.g., terrain) from elevated objects. The non-ground points are grouped into clusters by the processing unit 110 based on the spatial proximity of the points using clustering algorithms (e.g., density-based spatial clustering of applications with noise) or k-means. Each cluster can represent a potential obstacle or terrain feature.

For each cluster, the processing unit 110 (at 216) extracts features to help classify the cluster as an obstacle or a terrain feature. These extracted features can include the height of the cluster of data points above the ground. The processing unit 110 can identify objects that are significantly elevated above the ground as obstacles (e.g., data point clusters that are at least a threshold height above the ground). The processing unit 110 can examine the dimensions (e.g., width, height, and/or depth) and shape of the clusters to differentiate between obstacles and terrain. For example, small, irregularly shaped clusters may be identified by the processing unit 110 as obstacles (e.g., rocks or debris), while larger, flatter clusters may represent terrain features (e.g., slopes or embankments). The processing unit 110 can examine reflectivity values of the data points in the cluster. The data points having greater reflectivity may be identified as metallic objects (e.g., obstacles such as other equipment), while lower reflectivity data points may be identified as the terrain. The processing unit 110 can examine the data points in the clusters to determine whether the cluster(s) is or are moving. If a cluster is detected by the processing unit 110 to be moving (e.g., using temporal data from consecutive LiDAR scans), the processing unit 110 can identify that cluster as being an obstacle (e.g., a person, animal, or vehicle).

The processing unit 110 (at 216) can classify each cluster as either an obstacle or a terrain feature using machine learning and/or rule-based algorithms. The processing unit 110 can compare the data and values to predefined thresholds for this classification. For example, predefined thresholds for features like height, size, and reflectivity are used to classify clusters. Clusters having a height above a certain threshold (e.g., 0.5 meters) are classified as obstacles, while clusters with large, flat shapes are classified as terrain features. The processing unit 110 can use supervised learning models (e.g., decision trees, support vector machines, or neural networks) trained on labeled datasets to classify clusters based on extracted features. These models can learn complex patterns and improve classification accuracy over time.

The processing unit 110 (at 216) can use temporal data from consecutive LiDAR scans to refine the classification of clusters. Static objects (e.g., rocks, terrain features) have data points that remain in the same or substantially same location across multiple scans. Conversely, dynamic objects (e.g., personnel, vehicles) may have data points that change position over time and are classified as obstacles. The processing unit 110 can compare a current point cloud with previous scans to detect newly introduced objects, which may be identified as obstacles.

The processing unit 110 (at 216) can integrate or fuse data from other sensors to improve the cluster classification. For example, the processing unit 110 can use the movement data from the movement sensor 160 to account for the roll, pitch, and/or yaw of the asset. This helps the processing unit 110 correctly identify terrain features even while the asset is on uneven ground. The processing unit 110 can use GNSS location information to differentiate between stationary obstacles and terrain features in the context of the location of the asset.

The processing unit 110 (at 216) can repeatedly update the classification of clusters as new point cloud data is collected. For example, the processing unit 110 can dynamically change the classification of an object from a terrain feature to an obstacle responsive to the cluster starting to move in successive scans.

The processing unit 110 (at 216) can generate the terrain map by converting the processed point cloud data into a structured representation. The processing unit 110 divides the terrain into a grid of cells (e.g., a 2D raster grid). For each cell, the processing unit 110 calculates an average, minimum, or maximum elevation of the data points within each cell. If no points exist in a cell, interpolation methods (e.g., nearest neighbor or bilinear interpolation) can be used by the processing unit 110 to estimate the elevation for that cell. The terrain map may be smoothed using techniques such as Gaussian filtering to reduce abrupt changes and create a more realistic representation. The terrain map can be integrated into the machine guidance system 100 to assist with path planning, grade control, and obstacle avoidance.

The processing unit 110 (at 216) can repeatedly update the terrain map as new point cloud data is collected. For example, as the asset moves, new point cloud data is merged with the existing terrain map to provide real-time updates. The processing unit 110 can detect changes in the terrain (e.g., newly excavated areas or obstacles) by comparing the updated point cloud with the existing map.

The processing unit 110 (at 216) generates the terrain map as a three-dimensional terrain map in real-time (e.g., the terrain map is generated or updated as the data is collected without introducing additional delays outside of normal computer processing). This terrain map can be created using data from optical sensors 120, 130, location data from the location sensors, and movement data from the movement sensor 160. The processing unit 110 differentiates obstacles from terrain features using these data sources.

d. Position and Orientation Calculation

At 218, the location data from the location sensors and the movement data from the movement sensor 160 is analyzed to determine the real-world position and orientation of the asset. The processing unit 110 can analyze the GNSS data from 212 and the IMU data from 210 to determine the geographic position and orientation (or heading) of the asset in a coordinate frame, such as the north-east-down (NED) coordinate frame. At 220, the processing unit 110 analyzes the terrain data from 216 and the movement data from 210 to map the terrain surrounding the asset (including any detected obstacles) in the NED coordinate frame or another coordinate system.

At 222, the reflector data from 214 is analyzed along with known dimensions of the asset to determine the position and orientation of the arm of the asset and/or of the attachment, such as the cutting edge of the bucket attachment. The processing unit 110 can determine the positions and orientations using models that mathematically describe the asset configuration through the use of forward kinematics.

At 224, the position and orientation of the asset from 218 and the position and orientation of the attachment (e.g., the cutting edge of the bucket attachment) from 222 are examined to calculate the elevation of the attachment (e.g., the cutting edge of the bucket attachment).

For example, the processing unit 110 (at 224) can determine the elevation of the cutting edge of the bucket by combining the position and orientation of the loader (from 218) with the position and orientation of the cutting edge of the bucket attachment (from 222). The processing unit 110 can apply geometric transformations and kinematic relationships to map the relative position of the cutting edge to the coordinate system (e.g., the global coordinate system). The position and orientation of the asset (e.g., in X, Y, and Z coordinates) is determined using location data and movement data. The orientation of the asset (e.g., roll, pitch, and yaw) also is provided by the movement data and the location data. The relative position of the cutting edge of the bucket with respect to the asset is determined using data from the optical sensors 120, 130 and the known relative position of the reflector on the bucket to the cutting edge of the bucket. For example, the orientation of the cutting edge (e.g., tilt angle) can be calculated or derived from the geometry of the bucket. To determine the elevation of the cutting edge, the processing unit 110 can define the position and orientation of the asset in a coordinate system (e.g., a local coordinate system). The position and orientation of the cutting edge of the bucket are calculated relative to this local coordinate system. The processing unit 110 uses the position and orientation of the asset to transform the relative position of the cutting edge to the asset into the global coordinate system.

At 226, the elevation of the terrain can be determined from the position and orientation of the terrain from 220. The processing unit 110 can determine the terrain elevation using the position and orientation of the terrain derived in 220. The processing unit 110 examines the point cloud data generated by the optical sensors 120, 130 to calculate the elevation of the terrain at specific locations. This information may be used to display or otherwise provide the current state of the asset via a user interface—for example, either as raw values or in relation to a three-dimensional site plan.

e. Operation without Reliance on GNSS

While the location sensors may include GNSS antennas 145, 155 and receivers 140, 150, in some embodiments, the machine guidance system 100 does not include the antennas 145, 155 or receivers 140, 150, or can operate while the location sensors are inoperable or do not have access to satellite signals. For example, the machine guidance system 100 can operate indoors or in subterranean areas without having access to GNSS (e.g., GPS) signals.

In such a situation, reflectors (e.g., passive reflectors) can be placed in known locations off-board the asset. For example, the reflectors can be placed on walls or structures as reference points for positioning. The optical sensors 120, 130 and processing unit 110 can detect these off-board reflectors using point cloud data similar to how the optical sensors 120, 130 and processing unit 110 detect the reflectors onboard the asset. The size and/or shape of these off-board reflectors as detected by the processing unit 110 can indicate the location of the asset to the processing unit 110. For example, if square-shaped reflectors are used, the processing unit 110 can examine the point cloud data to determine whether the reflectors appear to have a square shape, a rectangular shape, a diamond shape, or the like. These different detected shapes (as well as the detected sizes) of the off-board reflectors can indicate how far (e.g., based on detected size) and the relative location of (e.g., based on the detected shape) the asset (or the optical sensor 120 and/or 130) relative to the off-board reflector. This feature allows the machine guidance system 100 to function in environments where GNSS satellite signals are unavailable, such as underground construction sites, mines, warehouses, etc.

### III. Example Asset

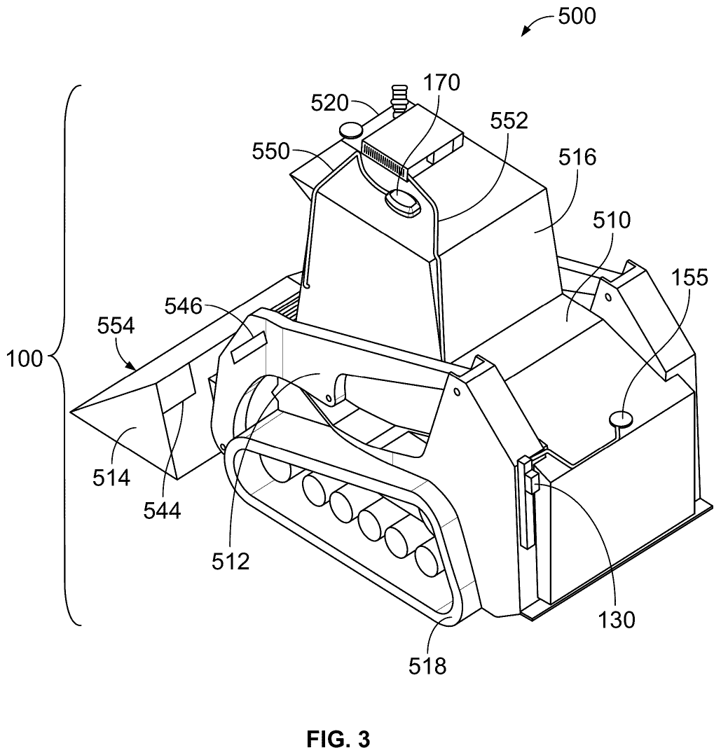

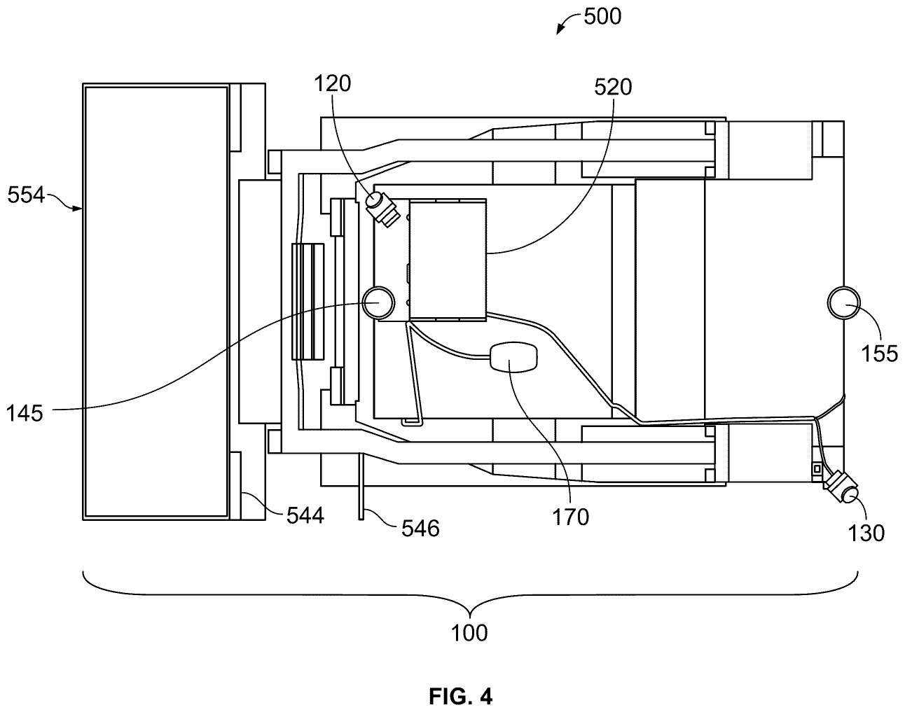

FIG. 3 is a perspective view of one example of the machine guidance system 100 shown in FIG. 1 onboard an asset 500. FIG. 4 is a top plan view of the machine guidance system 100 and the asset 500 shown in FIG. 3. The asset 500 is illustrated as a track loader that may be manually, semi-autonomously, and/or autonomously operated using the machine guidance system 100 described above. It should be understood that this example embodiment is provided to describe the various capabilities of the machine guidance system 100 and not to limit all embodiments of the inventive subject matter described herein.

The asset 500 includes a main body 510 connected to a lift arm 512, which is in turn connected to a bucket attachment 514. Other types of attachments may be attached to the lift arm 512, such as a tooth bucket, a mower, a dozer blade, a soil conditioner, a grapple, a trencher, or the like. The asset 500 also includes a cab 516 that provides an enclosure from which the operator can operate the asset 500. The asset 500 further includes a track 518 that enables movement of the asset 500 across rugged terrain. In some embodiments, the asset 500 may include wheels to move.

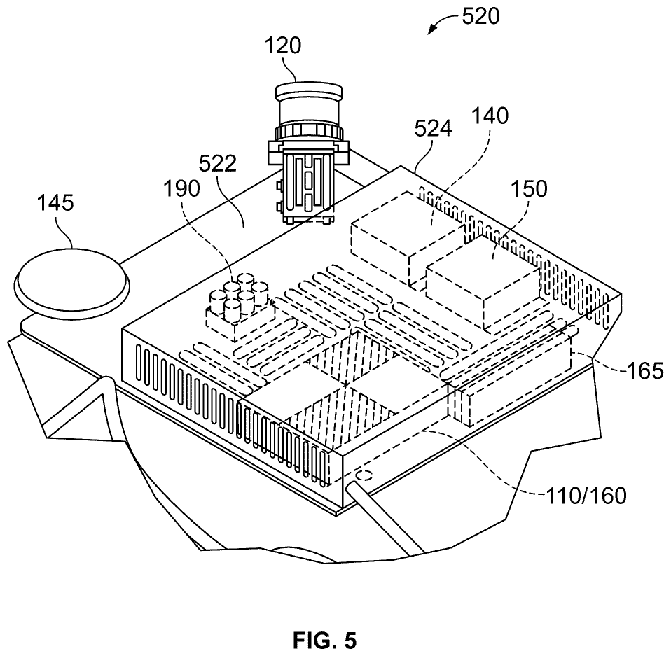

With continued reference to the asset 500 and the machine guidance system 100 shown in FIGS. 3 and 4, FIG. 5 illustrates a perspective view of a machine guidance assembly 520. The machine guidance system 100 of the asset 500 includes a machine guidance assembly 520 rigidly mounted on top of the cab 516. In some embodiments, the machine guidance assembly 520 may be mounted or located elsewhere on or in the asset 500. The machine guidance assembly 520 includes a rigid plate 522 on which is mounted a ruggedized enclosure 524 that provides isolated interfaces to the processing unit 110 and movement sensor 160, the communication network device 165, the front GNSS receiver 140, the rear GNSS receiver 150, and a power splitter 190. The cover of the ruggedized enclosure 524 is removed in FIG. 5 to show these components.

Also mounted to the rigid plate 522 is the front GNSS antenna 145 and the front optical sensor 120. In this example, the front GNSS antenna 145 is mounted on the rigid plate 522 at a location that is as far forward as possible along the x-axis of the asset 500 and generally centered along the y-axis of the asset 500. The front optical sensor 120 can be mounted on the rigid plate 522 at a location that allows the door of the cab 516, if so configured with a door, to be opened and closed, avoids contact with the arm 512 as the arm 512 is raised and lowered, and provides a line of sight to the arm/attachment joint when the arm 512 is lowered.

As shown in FIGS. 3 and 4, the asset 500 includes the rear GNSS antenna 155 mounted at the rear of the main body 510. The rear antenna 155 can be centrally located at the rear of the main body 510 to be oriented in a straight-line with the front antenna 145 along the x-axis of the asset 500. In some embodiments, the locations of the front and rear antennas 145, 155 could both be shifted along the y-axis of the asset 500 so long as the straight-line orientation between the antennas 145, 155 is maintained. In some embodiments, the location of the rear antenna 155 could be offset with respect to the front antenna 145 along the y-axis of the asset 500 as long as the location of the rear antenna 155 can be calibrated based on data from the optical sensor 120 and/or the optical sensor 130, and/or based on manual measurements between the GNSS antennas 145, 155.

The machine guidance system 100 onboard the asset 500 also includes the rear optical sensor 130 mounted at or toward the rear of the main body 510. The rear optical sensor 130 can be located on the left side of the rear of the main body 510 to provide a line of sight to a first attachment reflector 544 placed on the left side of the bucket attachment 514 and a second arm reflector 546 placed on the left side of the lift arm 512 of the asset 500. The reflectors 544, 546 may be onboard the asset 500 in that the reflectors 544, 546 are mounted to the asset 500 or the attachment 514 that is coupled with the asset 500. The onboard reflectors 544, 546 may be passive reflectors as described above. The reflectors 544, 546 can be positioned to be within the field of view of the front optical sensor 120 such that one or more than one line of sight exists between the front optical sensor 120 and each of the reflectors 544, 546, or at least one of the reflectors 544, 546. In some embodiments, the front and rear optical sensors 120, 130 track movement and/or positions of the lift arm 512 and bucket attachment 514 throughout their entire range of movement, and can be positioned to provide a 360-degree field of view around the asset 500.

The asset 500 further includes the 5G/LTE/WiFi antenna 170 mounted at a fixed location on top of the cab 516. The asset 500 includes a first harness 550 that connects the machine guidance assembly 520 to the power adapter 195 located within the cab 516, as well as a second harness 552 that connects the machine guidance assembly 520 to the rear antenna 155 and rear optical sensor 130. In some embodiments, all of the components of the machine guidance assembly 520, the front antenna 145, the front optical sensor 120, the rear antenna 155, and the rear optical sensor 130 are rigidly attached to the asset 500 so that the deflections are less than 0.1 millimeters with 5G shock and vibration. Also, the asset 500 also includes the ACU 180 and various components located within the cab 516, including the onboard computing device 175, the input device 182, output devices 184, 186, and the power adapter 195.

### IV. Calibration and Setup

The processing unit 110 is configured to execute guidance software during operation of the asset 500. The guidance software is implemented across four processes-vision, asset observer, navigation, and map or mapping. In the vision process, the processing unit 110 analyzes data from the optical sensors 120, 130 to determine parameters for the reflectors, real-time terrain around the track loader, and any real-time obstacles near the track loader. An example vision process can describe at least part of the calibration and setup of the machine guidance system 100 for an asset 500.

In the asset observer process, the processing unit 110 analyzes data from the location sensors 140, 145, 150, 155 and reflector position data (as provided or output by the vision process) to provide asset status messages that contain the real-world geographic position and orientation of the asset 500, also referred to as the state of the asset 500. In the navigation process, the processing unit 110 configures boundaries and keepouts, and organizes the boundaries and keepouts into tasks. The processing unit 110 also stores an aggregation of terrain data and progress on a task or globally at various resolutions. This data may be sent to the user interface (e.g., the onboard or in-cab computing device 175) so that the operator can see real-time terrain updates, as well as calculated cut/fill and other progress information.

In the map process, the processing unit 110 stores terrain data (as provided by the vision process) in association with cells of a map grid in a NED (North-East-Down) coordinate system. In general, a NED coordinate system is a local, Cartesian coordinate system that may be used in navigation or otherwise. In some examples, each cell includes the terrain elevation within that cell, the goal terrain elevation within that cell, information on whether an obstacle is located within that cell, and any other types of information relating to the terrain.

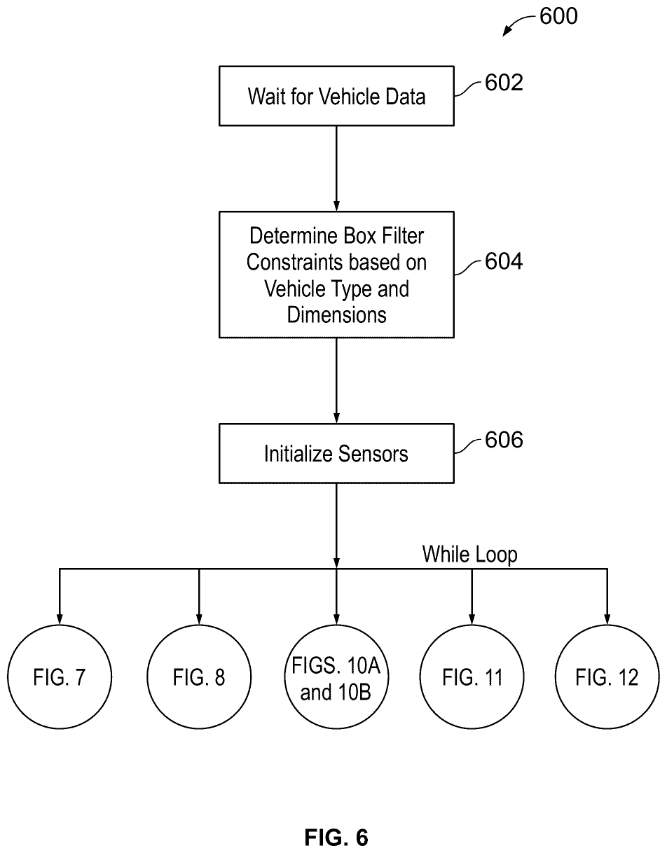

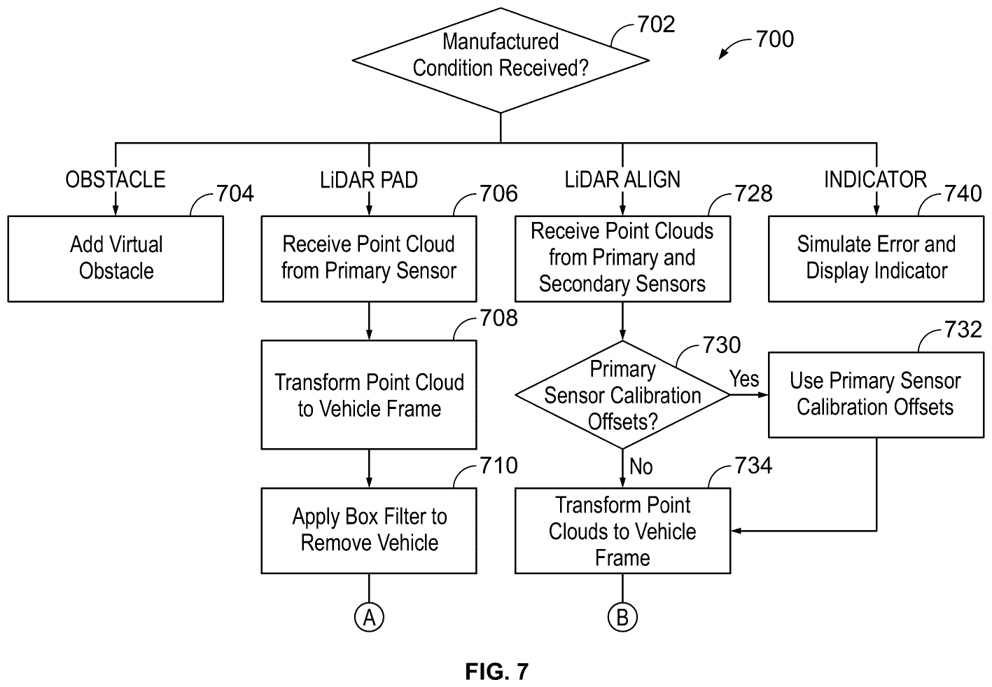

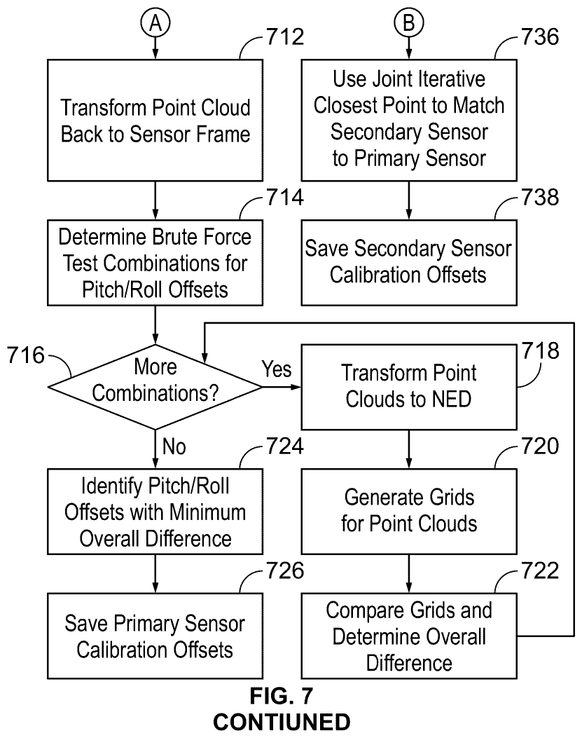

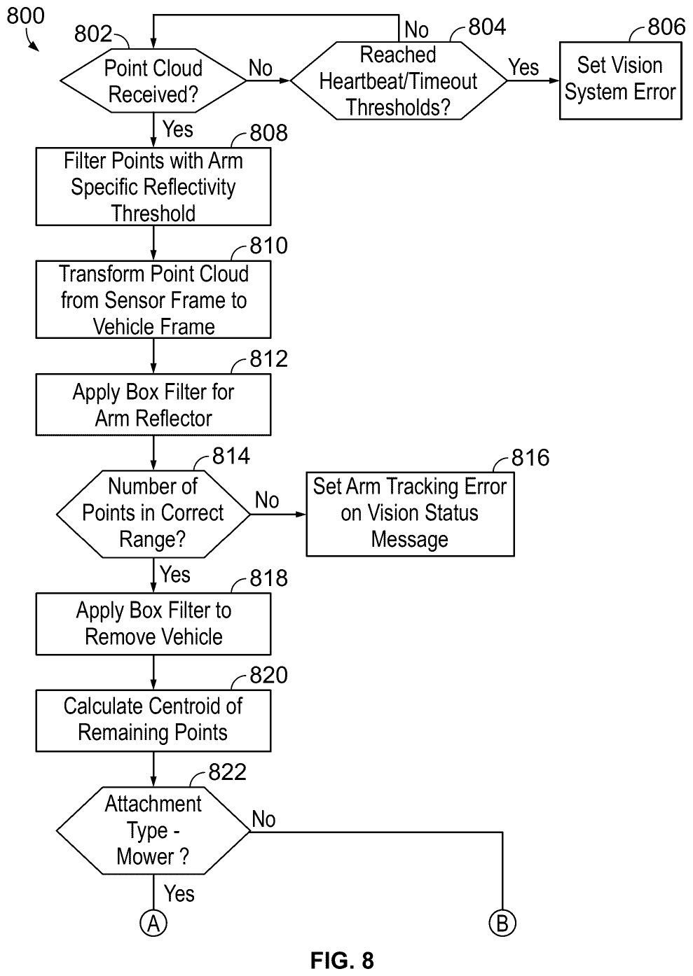

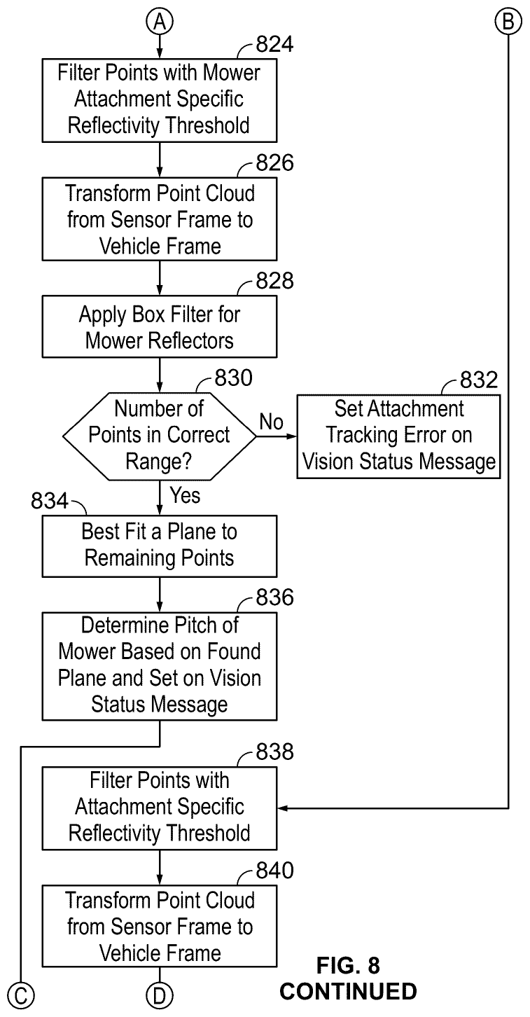

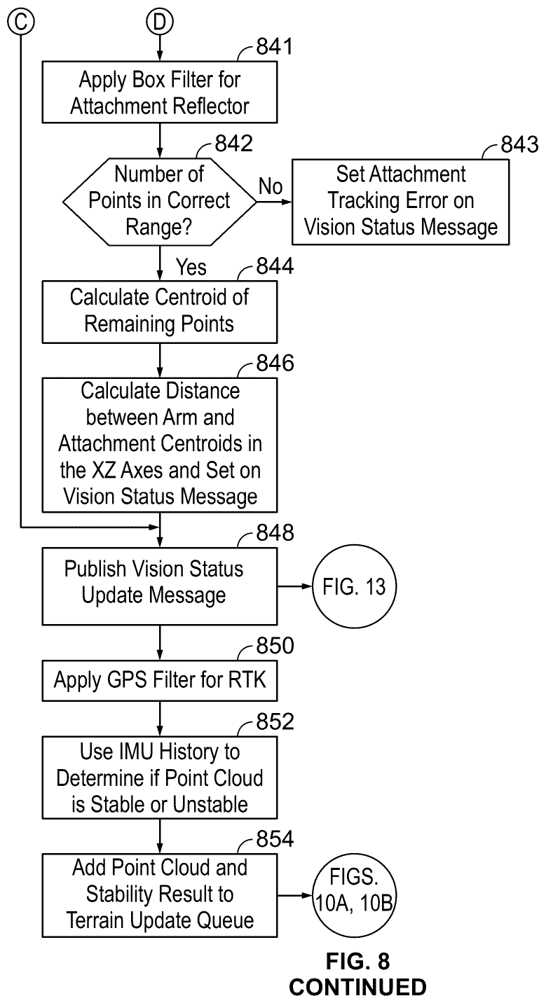

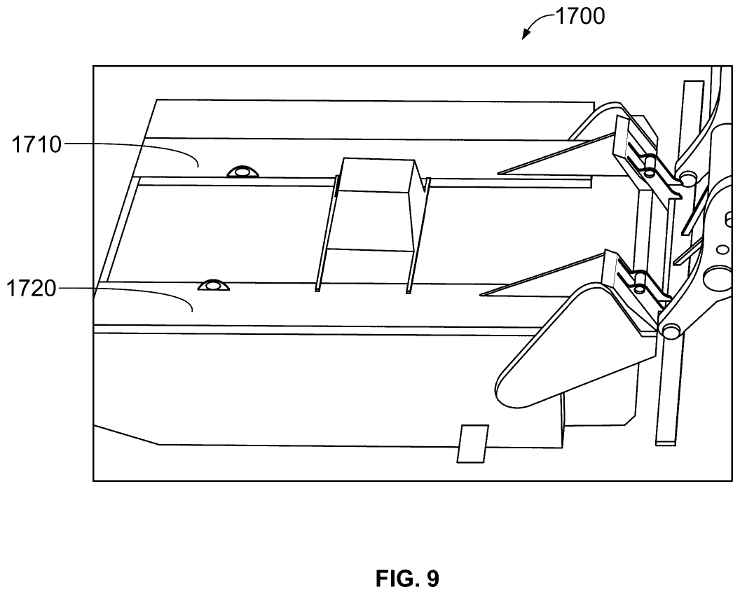

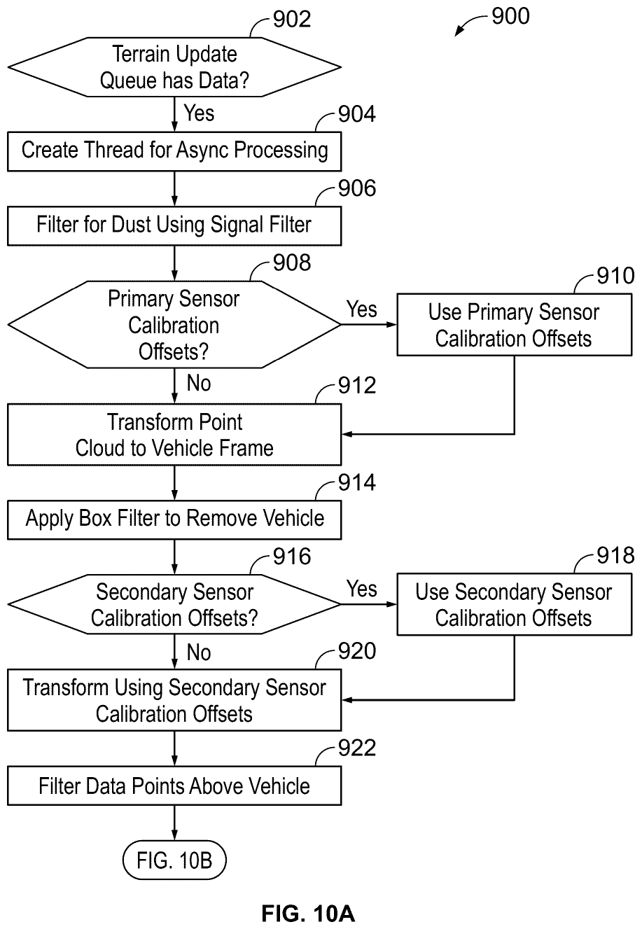

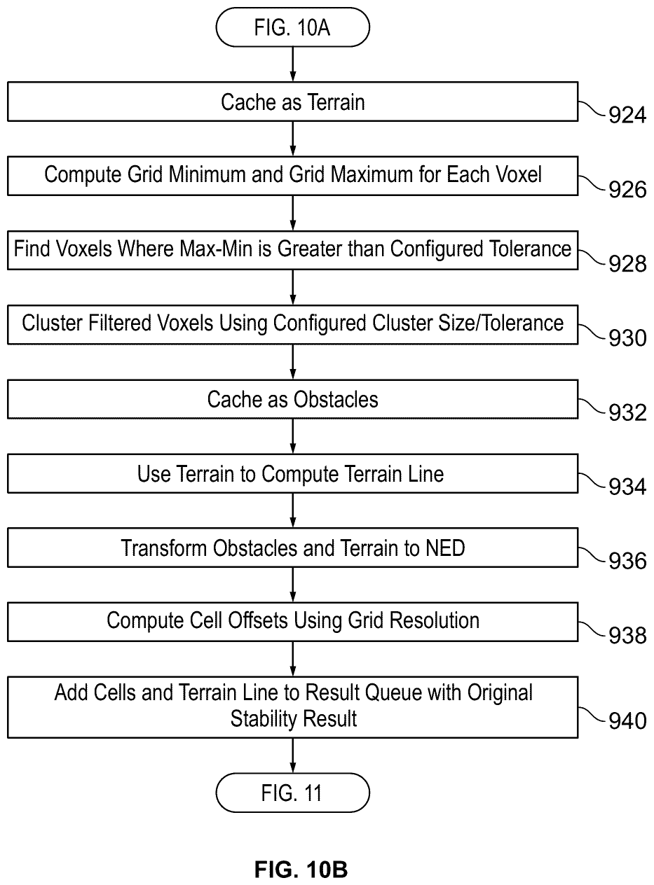

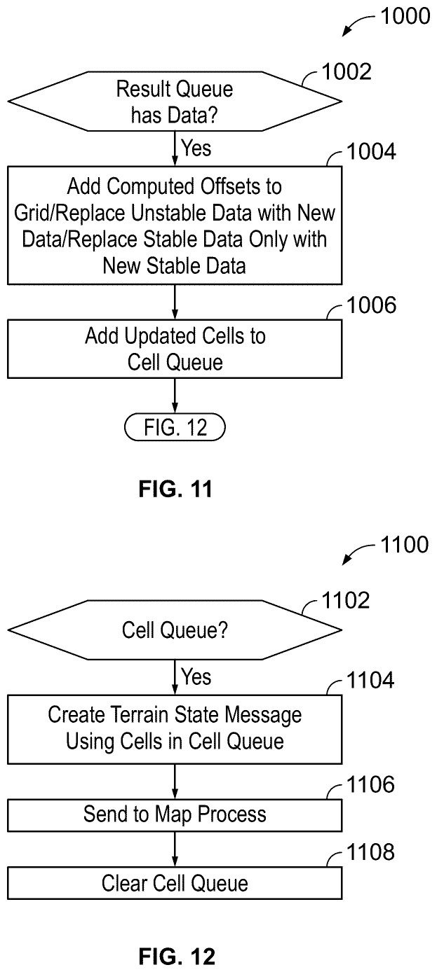

FIGS. 6 through 8 illustrate flowcharts of a vision process or method that can be used to calibrate and setup the machine guidance system 100 of the asset 500. The vision process includes an initialization process 600 (shown in FIG. 6), a while loop that allows the repeated execution of different processes, including a manufactured condition process 700 (shown in FIG. 7), an arm/attachment detection process 800 (shown in FIG. 8), a terrain detection process 1000 (shown in FIGS. 10A and 10B), an internal grid update process 1100 (shown in FIG. 11), and a map update process 1200 (shown in FIG. 12). The processes 700 and 800 are used for calibration or setup of the machine guidance system 100 prior to usage at a work site, while the terrain detection process 1000, the internal grid update process 1100, and the map update process 1200 can be used during operation of the asset 500 and the machine guidance system 100 at the worksite and following the calibration and setup. These methods or processes can be performed by the processing unit 110 and/or other components of the system 100, as described herein.

a. Initialization Process

In the initialization process 600 is shown in FIG. 6, at 602, the process waits for vehicle data. This data also can be referred to as asset data. The processing unit 110 can wait until the vehicle data is provided by the sensor suite and/or by the operator. In some examples, the operator inputs the vehicle data, such as the type of asset to be operated, the attachment to be used with the asset, and one or more operating parameters (such as grade, vertical offset, and tolerance). The operator can use the input device 182 in the cab 516 of the asset 500 to input the vehicle data. Alternatively, the vehicle data may be input using the onboard computing device 175. The asset 500 is turned on or activated, and the grade is set as vehicle data. The grade can be set by automatically (under control of the processing unit 110 and/or the asset control unit 180) or manually moving the asset attachment to the desired reference elevation for the grade, and optionally confirming this selection using the input device 182 and/or computing device 175. A vertical offset is input as vehicle data. The vertical offset allows adjustment of the grade that was set up or down by a specified amount (e.g., one inch).

The tolerance is set as additional vehicle data. The tolerance defines how close the attachment must be to the target grade (the grade that was set) for the machine guidance system 100 or processing unit 110 to decide that the attachment (or edge of the attachment) is “on grade.” For example, if the tolerance is set to two inches, then the cutting edge of the bucket must be within two inches of the grade that was set. Otherwise, the processing unit 110 determines that the attachment is not on grade. The processing unit 110 can then automatically implement responsive actions, such as raising the attachment, stopping movement of the asset, preventing further lowering of the attachment (while allowing lifting or other movement of the attachment), etc. The tolerance can be adjusted in increments, for example, by three inches, to suit the requirements of the project.

The grade and vertical offset settings can be reset if needed, which resets the machine guidance system 100 and allows the setup process to begin again. Throughout the process, the operator can use the physical buttons or switches in the cab 516 and/or the computing device 175 as the input device 182 to make selections and adjustments, enabling a straightforward and phone-free setup experience. More than one computing device 175 may be used. For example, an additional computing device 175 may be off-board the asset and used to set the grade, offset settings, or the like (e.g., by a supervisor).

The onboard computing device 175, such as a mobile phone, can operate using a software application that presents a user interface on the computing device 175. The computing device 175 can communicate input received via this application to the machine guidance system 100 (e.g., using the communication device 170). For example, one or more than one machine-readable indicia (e.g., a bar code, QR code, etc.) may be printed onto a surface of the cab 516 or onto a sticker or plate that is affixed to the surface in the cab 516). The indicia can be optically scanned by the onboard computing device 175 to initiate a software application operating on the computing device 175. This application can prompt the operator of the asset to input the vehicle data described above via the computing device 175. In other examples, the computing device 175 may be off-board the asset 500.

For example, the application can present a user interface workflow for setting up, operating, and troubleshooting the machine guidance system 100. The workflow can include a welcome and connection screen that identifies the type of asset 500, followed by step-by-step prompts for the operator to select and input the type of attachment of the asset (e.g., a bucket with a smooth or flat edge, or a bucket with a toothed edge), and select and input the measurement reference location (e.g., the location that the processing unit 110 controls the asset 500 to move in order to position the reference location in desired locations). For example, the computing device 175 can present a graphical user interface asking the operator whether to use the outer ends of the teeth on the bucket edge as the reference point or the cutting edge of the bucket (from which the teeth project) as the reference point.

Subsequent prompts displayed on the computing device 175 direct the operator to set the grade by moving the attachment to a desired height, then input options for setting a vertical offset, if any, then options for specifying the grading tolerance, and selecting a display mode of the output devices 184, 186 (e.g., the light bars operating in standard, dual, or quad mode). Subsequent prompts or graphical user interfaces on the computing device 175 can provide visual examples and demonstrations of the output device 184, 186 operating in the different modes, such as by showing how the output devices 184, 186 use colored light-emitting diodes (LEDs) to indicate whether the attachment is above, on, or below grade, as well as how the output devices 184, 186 visually convey track or asset elevation, bucket edge position, and vehicle tilt. A summary and settings screen can be displayed on the computing device 175 to communicate the current asset status, grade settings, attachment type, and mode of the output devices 184, 186.

The onboard computing device 175 can present several troubleshooting and error handling screens or graphical user interfaces that list detected issues such as missing reflectors 544, 546, obstructions of the antennas 145, 155, connection problems for the sensors 120, 130, 160 and/or receivers 140, 150, undetected attachments, etc. For each issue, the interface provided on the onboard computing device 175 provides step-by-step instructions and annotated photos to help the operator resolve the problem, including checking hardware connections, cleaning sensors 120, 130, 160, and ensuring clear lines of sight for the antennas 145, 155. The workflow that is presented on the onboard computing device 175 is intuitive, thereby guiding the operator through setup, operation, and troubleshooting with clear visual and/or textual feedback at each stage.

At 604 in the method 600 shown in FIG. 6, box filter constraints are determined based on the asset type and dimensions of the asset. These box filter constraints define the one or more than one box filters that are used for processing the point cloud data from the optical sensors 120, 130, as described above. Different box filter constraints can be calculated. For example, the box filter constraints can define different box filters, including a box filter for the asset 500, another box filter for the arm reflector 546, another box filter for the attachment reflector 544, and the like. At 606, the sensors in the sensor suite are initialized based on the configuration of the asset 500. For example, certain operating parameters for the front optical sensor 120 and the rear optical sensor 130 are initialized, such as the horizontal field-of-view resolution, update rate, etc.

Following 606, the method 600 proceeds through one or more of the methods 700, 800, the terrain detection process, the internal grid update process, or the map update process. These methods 700, 800, the terrain detection process, the internal grid update process, and/or the map update process can be performed sequentially or in series, in parallel, or a combination thereof.

b. Manufactured Condition Process

FIG. 7 illustrates a flowchart of one example of the manufactured condition process or method 700. The method 700 may per performed during the initialization process 600 (see FIG. 6) by the machine guidance system 100 (see FIG. 1), or otherwise performed. At 702, a decision is made as to whether a manufactured condition message type has been received. A manufactured condition message type refers to a message or status notification generated by the machine guidance system 100 to indicate a predefined or expected operational state, configuration, or diagnostic result of the machine guidance system 100 or the components of the machine guidance system 100 and/or asset 500. These messages communicate that the machine guidance system 100, sensor 120, 130, 160, the receivers 140, 150, attachment, or the like, is in a particular condition as intended by the manufacturer or as required for proper operation. If a manufactured condition message is received, then flow of the method 700 can proceed along one or more than one sub-processes or methods of the method 700, such as an obstacle sub-process (e.g., at 704), a first optical sensor sub-process (also referred to as a LiDAR pad sub-process and described in connection with 706, 708, 710, 712, 714, 716, 724, 726), a second optical sensor sub-process (also referred to as a LiDAR align sub-process and described in connection with 718, 720, 722, 728, 730, 734, 736, 738), or an indicator sub-process (e.g., at 730 and 732). Each of these sub-processes can represent the operations performed by the processing unit 110. If no manufactured condition message is received, then flow of the method 700 may terminate and return to another process 800, the terrain detection process, the internal grid update process, or the map update process, or operation in the method 600.

As described above, if a manufactured condition message is received, then flow of the method 700 can proceed from 702 toward 704 to the obstacle sub-process or to one or more than one of the first optical sensor sub-process, the second optical sensor sub-process, and/or the indicator sub-process. At 704, the obstacle sub-process adds a virtual obstacle corresponding to an obstacle located in the real-world at the worksite. A user interface (e.g., on the onboard computing device 175) is displayed that receives input to define the location of the virtual obstacle. The map sub-process uses this information to store the virtual obstacle in association with the applicable cells of the map grid. The operator may set a time at which the virtual obstacle is to be removed from the cells of the map grid. The virtual obstacle can be created to provide a defined location (e.g., geographic coordinate), defined area (e.g., two dimensional area), or volume (e.g., three dimensional space).

The first optical sensor sub-process can be used to calibrate the front optical sensor 120 (which is the primary sensor in this example) when the asset 500 is in a designated state (e.g., in a stationary position on a known flat pad or surface). At 706, point cloud data is received from the front optical sensor 120 and, at 708, the point cloud data is transformed from the sensor coordinate frame to the asset coordinate frame of the asset 500. At 710, at least one of the box filters for the asset 500 is applied to the point cloud data from the front optical sensor 120 to remove data points associated with the asset 500. At 712, the filtered point cloud data from the front optical sensor 120 that was transformed from the vehicle coordinate frame of the asset 500 is transformed back to the sensor coordinate frame. This can ensure that the data points are effectively used to identify the asset 500 and then returned to the format or coordinate frame useful for one or more other processes performed by the processing unit 110.

At 714, a brute force process is initiated to determine pitch and roll calibration offsets for the front optical sensor 120. These calibration offsets may be used to align the front optical sensor 120 with the front locator antenna 140 (which can serve as a reference point for the system 100 in this example). To perform this process, the processing unit 110 can determine the numerical values of desired test combinations of candidate pitch and roll offset values for the asset 500. In some embodiments, the test combinations are numerical values that are −2.0 degrees to 2.0 degrees from original estimates for the pitch and roll offsets with a resolution of 0.01 degrees. Alternatively, another upper or lower bound to this range may be used, and/or the resolution may be larger or smaller, as needed for the project being performed by the asset 500. The processing unit 110 may select random, quasi-random, or predetermined values for the pitch and roll offset values to be tested or examined.

At 716, the pitch and roll offsets for the first test combination are identified and used to make minor adjustments to the orientation of the filtered point cloud data. The processing unit 110 can adjust the orientation of the filtered point cloud data so that the cloud data accurately represents the real-world terrain and objects relative to a consistent reference frame such as of the asset, the sensor 120, or another coordinate frame. The processing unit 110 can apply these offsets due to the optical sensor 120 not always being perfectly level or aligned with a reference frame due to uneven terrain, slopes, mounting imperfections, etc. If the pitch and roll of the optical sensor 120 are not accounted for, the point cloud data may be skewed, and the calculated elevations and positions of terrain features and obstacles may be inaccurate. The processing unit 110 calculates a rotation (or transformation) matrix that describes how to rotate the point cloud data to correct for the orientation of the optical sensor 120. The points in the filtered point cloud are mathematically rotated using this matrix so that features in the data correspond to the true positions and elevations in the reference frame.

At 718, the adjusted point cloud data is transformed from the sensor coordinate frame to the NED coordinate frame. At 720, the transformed point cloud data is used to generate a grid and, at 722, the grid is compared to the flat pad or surface on which the asset 500 is located to determine the overall difference (or error) between the grid and the flat pad or surface. If the grid is not parallel to or is otherwise misaligned to the flat pad or surface (e.g., a reference surface), then there is a calibration error for that grid. For example, if the grid of cloud data points are slightly angled by two degrees to the reference surface, then there is a calibration error representative of two degrees. This calibration error is identified or calculated by the processing unit 110 and associated with (e.g., stored with) the offset values used to generate that grid.

The operations of 716-722 can be repeated for each test combination (e.g., for each pair or several pairs of the pitch and roll offset values). At 724, the test combination with the pitch and roll offsets that result in the minimum overall difference (or the lowest calibration error) are identified. The processing unit 110 can calculate this difference as the smallest difference between the grid and the pad or surface. At 726, those pitch and roll calibration offsets are saved for use as the calibration offsets for the front optical sensor 120. For example, the calibration offset values for the front optical sensor 120 can be applied to the point cloud data that is output by the front optical sensor 120 during operation of the asset 500. This calibration process and adjustment can be repeated, such as periodically, on demand, each day, or the like. The adjusted point cloud data can help the asset 500 safely and autonomously move while avoiding collisions with obstacles and/or while autonomously performing work (e.g., grading a worksite).

The second optical sensor alignment process can be used to calibrate the rear optical sensor 130 (which is the secondary sensor in this example) to be aligned with the front optical sensor 120. This alignment may result in the orientations of the point cloud data obtained by each optical sensor 120, 130 being aligned with each other, without having to physically or mechanically change the orientation or location of either optical sensor 120, 130.

At 728, point cloud data is received from the front optical sensor 120 and the rear optical sensor 130. At 730, a decision is made whether there are calibration offsets for the front optical sensor 120 (such as the calibration offsets determined using the first optical sensor pad process). If the processing unit 110 decides that there were offsets identified at 726, at 732, the calibration offsets are used to adjust the point cloud data received from the front optical sensor 120 and the process proceeds toward 734. If there are no calibration offsets for the front optical sensor 120, the process proceeds toward 734.

At 734, the point clouds received from the front optical sensor 120 (whether adjusted or not) and the rear optical sensor 130 are transformed from the sensor coordinate frame to the vehicle coordinate frame of the asset 500. At 736, a joint iterative closest point (ICP) algorithm is used to minimize the difference between the two point clouds and calculate the pitch, roll, yaw, and position (x, y, z) calibration offsets for the rear optical sensor 130. At 738, those calibration offsets are saved for use as the calibration offsets for the rear optical sensor 130. For example, the calibration offset values for the rear optical sensor 130 can be applied to the point cloud data that is output by the rear optical sensor 130 during operation of the asset 500. This calibration process and adjustment can be repeated, such as periodically, on demand, each day, or the like. The adjusted point cloud data can help the asset 500 safely and autonomously move while avoiding collisions with obstacles and/or while autonomously performing work (e.g., grading a worksite).

The indicator process is used by the processor unit 110 to simulate a sensor failure or logic error to determine whether the appropriate indicator (such as a light or symbol generated by an output device) is displayed to the operator. At 740, a particular sensor failure or logic error is simulated and the appropriate message is reported to the user interface to thereby test the indicator. For example, the processing unit 110 can intentionally generate a condition that mimics an actual fault. The faults that may be mimicked can be, for example, a disconnected sensor 120, 130, 160, a disconnected receiver 140, 150, a blocked antenna 145, 155, a missing reflector 544, 546, a software logic error that would affect data processing or attachment detection, etc. The processing unit 110 can simulate such a fault by generating or blocking communication of signals to and/or from various components of the machine guidance system 100. When such a simulated failure or error is triggered, the system 100 processes the failure of error as if the fault or error were an actual event occurring during normal operation. Upon detecting the simulated fault, the processing unit 110 can generate a corresponding error or warning message and send the message to the onboard computing device 175, which may include a display screen, LED light bar, or audio alert. The onboard computing device 175 can present the appropriate visual or audio indicator (e.g., a warning icon, a specific error message, or a change in light bar color or pattern) so that the operator is informed of the fault or error being mimicked. In the event of a real sensor malfunction or software issue during field operation, the processing unit 110 and system 100 is able to reliably operate to notify the operator.

c. Arm and/or Attachment Detection Process

FIG. 8 illustrates a flowchart of one example of an arm/attachment detection process or method 800. The method 800 can analyze the point cloud data received from the front and rear optical sensors 120, 130 to track the lift arm 512 and attachment 514 of the asset 500. This tracking is performed based on the positions and orientations of the arm reflector 546 and attachment reflector 544. This process 800 also allows for the tracking of other types of attachments, such as a mower attachment, as described below. In some examples, the point cloud data received from the front and rear optical sensors 120, 130 are fused with each other to enable the analysis of a single point cloud by the processing unit 110. Alternatively, the point cloud data received from the different sensors 120, 130 remain separate for analysis by the processing unit 110.

At 802, a decision is made whether point cloud data has been received (e.g., by the processing unit 110) while the arm of the asset 500 is within the field of view of the optical sensor 120 and/or 130. If not, at 804, a decision is made whether a heartbeat threshold and/or timeout threshold has been reached. The heartbeat threshold can be in the range of 1 to 10 missed messages (e.g., the number of regularly repeated messages that the optical sensors 120, 130 are to output point cloud data with the messages being missed or not received) and the timeout threshold can be in the range of 100 milliseconds to 1,000 milliseconds (e.g., the delay between consecutive messages from the optical sensor 120 and/or 130). Alternatively, other ranges may be used. If the applicable threshold(s) has or have been reached, the method 800 sets a vision system error at 806. This can involve the processing unit 110 directing an output device, computing device 175, or display to notify the operator of the sensor error. If not, the process 800 returns to 802.

If point cloud data has been received, the process 800 proceeds to 808. At 808, data points having reflectivity or signal values below a predetermined threshold specific to the lift arm 512 are filtered out to remove data points attributable to dust, debris, dirty reflectors 544, 546, etc. At 810, the filtered point cloud data is transformed from the sensor coordinate frame to the vehicle coordinate frame of the asset 500, as described above. At 812, a box filter for the arm reflector 546 is applied to the point cloud data to remove data points that are not associated with the arm reflector 546.

At 814, a decision is made whether the total number of filtered data points is within a predetermined range that includes the expected number of data points to be associated with the arm reflector 546. If the number of data points is not within the predetermined range of this expected number, the process 800 sets an arm tracking error on the vision status message at 816. The processing unit 110 can direct an output device to notify the operator of this error. There can be different causes for such an error, such as an object blocking the view between an optical sensor 120, 130 and the arm reflector 546, the arm reflector 546 falling off the asset 500, damage to the arm reflector 546, a dirty optical sensor 120, 130, too much dust in the environment, a foreign reflective object close to the arm reflector 546 (e.g., within the field of view of the sensor 120 or the sensor 130), or the like. Of course, other causes for error will be apparent to one of ordinary skill in the art. If the total number of data points is within the predetermined range, at 818, a box filter for the asset 500 is applied to the point cloud data to remove all data points associated with the asset 500. At 820, the (x, y, z) values of the centroid of the filtered data points are calculated. For example, the processing unit 110 can calculate the average of the coordinates of the points in the filtered point cloud data.

At 822, a decision is made whether the attachment type is a mower (such as a brush hog mower attachment). A mower attachment may be processed differently than other attachments because the mower attachment is more likely to be used in high brush (for example, brush that is five feet tall or more) and contain sticks, branches, brush, or other debris falling on the attachment.

With continued reference to the process 800 shown in FIG. 8, FIG. 9 shows an example mower attachment 1700 with two attachment reflectors 1710, 1720 placed thereon. To accommodate these environmental conditions, at least two additional reflectors 1710, 1720 that are relatively large in scale (e.g., larger than the reflectors 544, 546) are placed on the top surface of the mower attachment 1700 (or in another location that is within a field of view of the front optical sensor 120 and/or the rear optical sensor 130.

If the attachment type is a mower, at 824, data points having reflectivity or signal values below a predetermined threshold specific to the mower attachment 1700 are filtered out to remove data points attributable to dust and various types of debris. While the mower attachment 1700 is used in this example, other attachments may be used with additional reflectors 1710, 1720 attached, and the cloud data points associated with the attachment may be filtered in a similar way.

At 826, the point cloud data is transformed from the sensor coordinate frame to the vehicle coordinate frame of the asset 500. At 828, a box filter for the reflectors on the attachment is applied to the point cloud data to remove data points that are not associated with these reflectors. At 830, a decision is made whether the total number of filtered data points is within a predetermined range that includes a predetermined number of expected data points associated with the attachment reflectors 1710, 1720. If the number of data points is not within the predetermined range, the process 800 sets an attachment tracking error on the vision status message at 832. As described above, the processing unit 110 can communicate this error to the operator using output devices. There can be different causes for such an error, such as an object blocking the view between an optical sensor 120, 130 and the attachment reflectors 1710, 1720, at least one of the attachment reflectors 1710, 1720 falling off the asset 500, damage to the attachment reflectors 1710, 1720, a dirty optical sensor 120 or 130, too much dust or debris in the environment, or a foreign reflective object close to the attachment reflectors 1710, 1720 (e.g., within the field of view of a sensor 120 and/or 130). Of course, other causes for error will be apparent to one of ordinary skill in the art. If the total number of data points is within the predetermined range, the process 800 proceeds toward 834.

If there is debris covering part of the attachment 1700, the overall shape and orientation of the attachment reflectors 1710, 1720 can still be determined by the processing unit 110. At 834, the plane of best fit to the filtered data points is found. The processing unit 110 can find this plane of best using least squares fitting. The processing unit 110 calculates the plane that minimizes or otherwise reduces a sum of the squared distances from all the filtered data points to the plane.

At 836, the plane that is found at 834 is used to determine the pitch of the attachment 1700, and that pitch is set on the vision status message. For example, the processing unit 110 can output this message to indicate the set pitch to the operator via the onboard computing device 175. At 848, the vision status message can be published for use by a vehicle observer process.

The vehicle observer process is a software routine within the machine guidance system 100 (e.g., that directs the processing unit 110) to determine and track the real-world position and orientation (e.g., pose) of the asset 500 and its attachments in real time. The process involves the processing unit 110 receiving and analyzing data from the sensors 120, 130, 160, the receivers 140, 150, and/or reflector and terrain information. The processing unit 110 fuses and uses the fused sensor data to calculate parameters like the geographic location of the asset 500, the heading of the asset 500, the pitch of the asset 500, and the position and orientation of the attachment (e.g., the cutting edge of a bucket). The vehicle observer process publishes this information as a status message, which is used by other components of the system 100 for guidance, control, and display to the operator, ensuring accurate and up-to-date awareness of the machine's state and configuration during operation.

If the attachment type is determined to not be the mower attachment 1700 at 822 (e.g., the attachment is the bucket attachment 514), the process 800 proceeds toward 838. At 838, data points having reflectivity or signal values below a predetermined threshold specific to the other attachment (e.g., the bucket attachment 514) are filtered out to remove data points attributable to dust, etc. For example, the reflectivity values of the data points may vary between a lower or minimum value and an upper or maximum value. The predetermined threshold used to filter out data points having lower reflectivity values may be 50% of the upper or maximum value, 60% of the upper or maximum value, or another percentage. At 840, the point cloud data is transformed from the sensor coordinate frame to the vehicle coordinate frame of the asset 500. At 841, a box filter for the reflector 544 on the bucket attachment 514 is applied to the point cloud data to remove data points that are not associated with the attachment reflector 544.

At 842, a decision is made whether the total number of filtered data points is within a predetermined range that includes the expected number of data points to be associated with the attachment reflector 544. As described above, the expected number of data points can be determined by repeatedly measuring the number of data points that are detected and setting an expected range as a range of percentages of the number of data points between the lower or lowest number and the larger or largest number. If the number of data points is not within the predetermined range, the processing unit 110 can generate or set an attachment tracking error on the vision status message at 843. There can be different causes for such an error, such as an object blocking the view between an optical sensor 120, 130 and the attachment reflector 544, the attachment reflector 544 falling off the asset 500, damage to the attachment reflector 544, a dirty optical sensor(s) 120 and/or 130, too much dust or debris in the environment, or a foreign reflective object close to the attachment reflector 544 (e.g., within the field of view of the front optional sensor 120 and/or the rear optical sensor 130). Of course, other causes for error will be apparent to one of ordinary skill in the art. If the total number of data points is within the predetermined range, the process 800 proceeds toward 844.

At 844, the (x, y, z) values of the centroid of the filtered data points are calculated. At 846, the distance between the attachment centroid (from 844) and the arm centroid (from 820) in the XZ plane, and that distance along with the (x, y, z) values of the attachment and arm centroids are set on the vision status message. For example, the processing unit 110 can direct an output device to present this information to the operator. The process 800 proceeds toward 848 so that the vision status message can be published for use by the vehicle observer process.

At 850, the process 800 confirms that the GNSS receivers 140, 150 have determined the positions of the GNSS antennas 145, 155, respectively. Confirming these positions may be performed using RTK positioning technology. At 852, the movement sensor history from the movement sensor 160 is used to determine whether the point cloud data is stable or unstable. The movement sensor history can be movements previously sensed by the movement sensor 160. For example, the processing unit 110 can decide that the point cloud data is stable if the asset 500 is driven slowly around a worksite (e.g., slower than a threshold speed, such as five miles per hour). In contrast, the processing unit 110 can decide that the point cloud data is unstable if the asset 500 is driven rapidly around a worksite (e.g., at least as fast as the threshold speed) to cause excessive bouncing, in which case the accuracy of the data may be degraded. In some examples, the point cloud data received over a predetermined window (such as one to ten seconds) is analyzed by the processor 110 to calculate the standard deviation of the data points. If the standard deviation is at or below a predetermined threshold, the point cloud data is determined to be stable. However, if the standard deviation is above the predetermined threshold, the point cloud data is determined to be unstable. At 854, the point cloud data and stability results are added to the terrain update queue and processed using the terrain detection process described below.

The calibration and setup of the machine guidance system 100 for use with the asset 500 and the attachment can be validated. In one example, a validation kit comprising one or more sensors, such as one or more GNSS antennas 145, 155 and GNSS receivers 140, 150 may be used to validate the calibration and setup of the machine guidance system. The GNSS antennas 145, 155 can be positioned on the attachment, such as the cutting edge of the attachment. Location and/or orientation information about the attachment can be obtained from the additional GNSS receivers using satellite signals received by these additional GNSS antennas. This information is compared with the location and/or orientation information determined by the machine guidance system 100. If the location and/or orientation determined by the validation kit does not match or is not within a tolerance threshold of the location and/or orientation determined by the machine guidance system 100, then the processing unit 110 determines that the calibration and setup of the machine guidance system 100 is incorrect. One or more of the calibration and setup processes or methods described herein may then be repeated. Otherwise, the processing unit 110 determines that the calibration and setup of the machine guidance system 100 was successful, and autonomous or partially autonomous operation of the asset 500 can begin or continue.

### V. Terrain Detection Process

FIGS. 10A and 10B illustrate a flowchart of one example of a terrain detection process 900. The terrain detection process 900 represents operations performed by the processing unit 110 to analyze the point cloud data received from the front and rear optical sensors 120, 130 at 854 in the method 800 shown in FIG. 8 to identify and track the terrain surrounding the asset 500.

At 902, a decision is made as to whether a terrain update queue contains data to be processed. For example, the processing unit 110 can decide whether there is point cloud data from the optical sensors 120, 130 and the stability result added to a terrain update queue in 854 of the arm/attachment detection process shown in the method 800 in FIG. 8. If there is such data (e.g., in a tangible and non-transitory computer readable medium, or computer memory, of the processing unit 110 or accessible to the processing unit 110), the processing unit 110 can create a thread for asynchronous processing of the data at 904. Otherwise, the method 900 may terminate, wait to 902, or proceed to another operation described herein. In some embodiments, the processing delay between the arm/attachment detection process shown and described in the method 800 in FIG. 8 and the terrain detection process 900 is in the range of 50 milliseconds to 200 milliseconds.

At 906, the point cloud data is filtered so that data points having reflectivity or signal values below a predetermined threshold specific to the terrain are filtered out. The processing unit 110 can compare the reflectivity values and signal values of data points within the point cloud data from the optical sensor(s) 120, 130 to one or more than one predetermined threshold. Data points having reflectivity values or signal values that are below this threshold may be discarded or blocked from further use, as these data points may be attributable to dust, etc., and not reflection of light off any reflector 544, 546.

At 908, a decision is made as to whether there are calibration offsets for the front optical sensor 120 (such as the calibration offsets determined using the pad process shown in the method 700 in FIG. 7). If the processing unit 110 decides that there are calibration offsets, flow of the method 900 proceeds toward 910, where the point cloud data received from the front optical sensor 120 are adjusted using the calibration offsets. Flow of the method 900 can proceed toward 912. If there are no calibration offsets for the front optical sensor 120, the method 900 proceeds toward 912. At 912, the point clouds received from the front optical sensor 120 (whether adjusted or not) are transformed from the sensor coordinate frame to the vehicle coordinate frame of the asset 500.

At 914, a box filter for (e.g., associated with) the asset 500 is applied to the point cloud data to remove data points associated with the asset 500. For example, the box filter may have thresholds and limits empirically calculated or found to define the size, shape, and reflectivity of the asset 500. This box filter can be applied to the data points remaining in the point cloud data after filtering at 906.

At 916, a decision is made as to whether there are calibration offsets for the rear optical sensor 130. For example, the processing unit 110 can determine whether there are calibration offsets calculated using the align process shown in the method 700 in FIG. 7). If there are calibration offsets for the rear optical sensor 130, flow of the method 900 can proceed toward 918. At 918, the point cloud data from the rear sensor 130 are adjusted using these calibration offsets. Flow of the method 900 can proceed toward 920. If the processing unit 110 decides at 916 that there are no calibration offsets for the rear optical sensor 130, the method 900 can proceed from 916 toward 920.

At 920, the point clouds received from the rear optical sensor 130 (whether adjusted at 918 or not) are transformed (e.g., by the processing unit 110) from the sensor coordinate frame to the coordinate frame of the asset 500. At 922, the filtered, calibration adjusted, and transformed point cloud data is again filtered based on distance. For example, the data points located more than a predetermined distance above the front GNSS antenna 145 are filtered out, eliminated, or otherwise blocked by the processing unit 110 from future usage. This predetermined distance can be, for example, between one and five meters above the antenna 145. At 924, the remaining data points are identified or cached as terrain. For example, the processing unit 110 can store the remaining data points in the memory.

At 926, the point cloud data (that was identified as representing terrain) is projected into a voxel grid and, in each voxel, the data points are analyzed to identify the data point with the minimum height and the data point with the maximum height. For example, the processing unit 110 can select the data point that is lowest or lower than all other data points (or at least a designated fraction or number of data points) projected into the grid and the data point that is highest or higher than all other data points (or at least a designated fraction or number of data points) projected into the grid. At 928, one or more than one voxels (or volume elements) are identified as an obstacle to the asset 500. For example, the processing unit 110 can select the voxels in which the difference between the maximum and minimum heights is greater than a predetermined threshold as indicative of an obstacle. This obstacle can be another asset, a person outside the asset 500, an animal, a rock, a building, etc. At 930, the voxels identified as obstacles are clustered using a predetermined cluster size and tolerance. At 932, the clustered voxels are identified and stored or cached as obstacles.

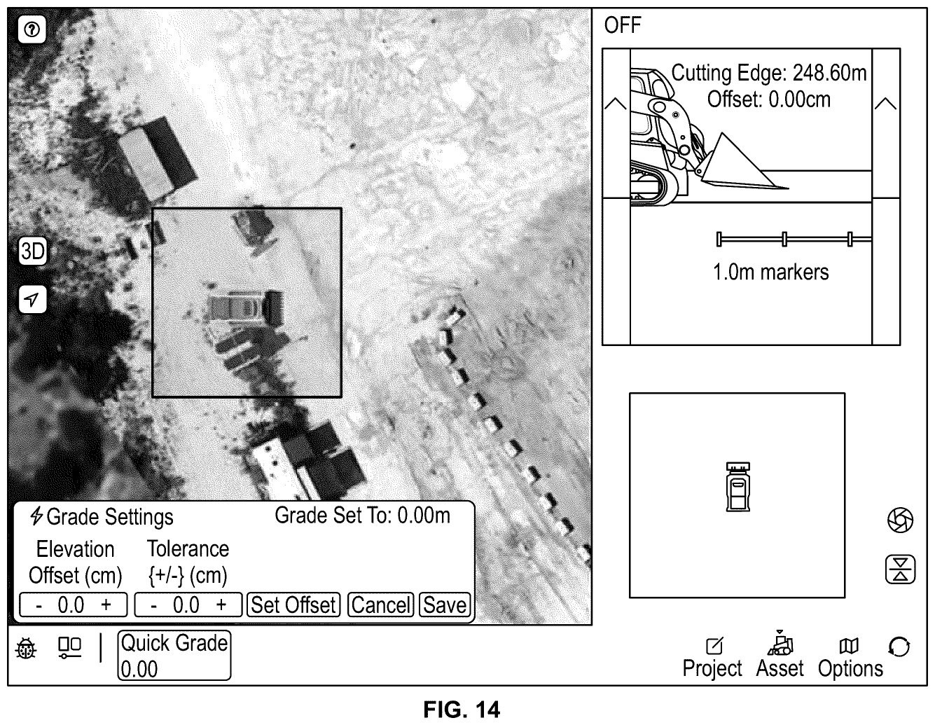

At 934, the terrain data identified as obstacles at 924 is analyzed to compute a terrain line. The processing unit 110 can calculate the terrain line as a real-time cross section of the terrain surrounding the asset 500. The processing unit 110 can provide or use the terrain line in the map process, and can display the terrain line to the operator during operation of the asset 500 (as shown in FIGS. 14 through 16). In some embodiments, the processing unit 110 can provide the terrain line to the ACU 180 (or may itself use the terrain line) for use in controlling the operation of the asset 500. For example, the processing unit 110 or the ACU 180 can automatically control movement of the asset 500 to avoid steep increases or decreases in grade, avoid contact with terrain obstacles, or the like. In some examples, the terrain line is provided at a higher resolution than the other map data. At 936, the terrain data identified at 924 and the obstacles identified at 932 are transformed from the coordinate frame of the asset 500 to the NED coordinate frame.

At 938, cell offsets of the cells associated with the terrain data and the cells associated with the obstacles are computed using the resolution of the map grid. Each cell offset includes integer values describing the (x, y) position of a cell within the map grid. The cell offsets can be indices or coordinate values that identify positions of individual cells within the map or grid used by the processing unit 110 for terrain detection and mapping. The terrain surrounding the asset 500 can be represented as a two-dimensional (2D) or three-dimensional (3D) grid, with each cell corresponding to a particular area or volume of the terrain. A cell offset is a pair (for 2D maps) or triplet (for 3D maps) of integer values that indicate the position of the cell relative to a reference point or origin in the grid. The cell offsets can be used by the processing unit 110 to identify, access, and update specific cells in the terrain map grid as new sensor data is processed. Each cell can store (or be stored with) information such as elevation, obstacle presence, or other terrain features in a memory of or accessible to the processing unit 110.

As point cloud data is collected from the optical sensors 120, 130, the processing unit 110 can map the data points in the point cloud data to specific cells in the grid based on the spatial coordinates of the data points. The processing unit 110 can calculate the cell offsets by converting the real-world coordinates of the data point to grid indices (e.g., by dividing by the grid resolution and rounding to the nearest integer). When new data is available (e.g., a new elevation measurement or obstacle detection), the processing unit 110 can use the cell offset to directly access and update the corresponding cell in the grid.

The resolution of the map grid may vary between different implementations. For example, each cell can be 0.1 meters along the x-axis and 0.1 meters along the y-axis. Thus, a cell that is located 10 meters from the origin along the y-axis will have a cell offset of (0, 100). In some embodiments, other cell offsets can be used. At 940, the cell offsets with associated terrain data and obstacles (computed at 938) are added to a result queue along with the stability result that was added to the terrain update queue at 854 of the arm/attachment detection process shown in the method 800 in FIG. 8. The result queue is a data structure of the terrain mapping and update processes of the processing unit 110. The result queue can be a portion of the memory used by the processing unit 110 to temporarily store and manage new or updated sensor data for grid cells before the new or updated data is integrated into the map. As the processing unit 110 processes incoming sensor data, the processing unit 110 identifies which cells in the terrain grid are affected by the incoming sensor data. The processing unit 110 computes updated values (such as elevation, obstacle presence, or stability status) for those cells. Each updated cell, along with the cell offset and associated data, can be added to the result queue. Once the processing for a batch of sensor data is complete, the processing unit 110 retrieves data from the result queue and applies the data to the corresponding cells in the terrain map. This allows the processing unit 110 to efficiently handle incremental map updates, avoid redundant processing, and ensure that the map is updated with relevant and recent data. The method 900 can repeat one or more additional times as additional data is obtained from the sensor suite, or can proceed to the internal grid update process 1000 shown in FIG. 10.

FIG. 11 illustrates a flowchart of one example of the internal grid update process 1000. The internal grid update process 1000 is performed by the processing unit 110 to manage real-time integration of new terrain and obstacle data into the map generated by the processing unit 110. As the sensor suite (e.g., the sensors 120, 130, 160, GNSS antennas 145, 155, and/or GNSS receivers 140, 150) collects sensor data, the processing unit 110 identifies the grid cells in the terrain map that are affected by or represented by the sensor data. The processing unit 110 calculated updated values for those cells, such as revised elevations or obstacle flags (e.g., identification of the cells as containing an obstacle outside the asset 500). The processing unit 110 replaces outdated or unstable data in the grid with the newer and/or more accurate data. This ensures that the processing unit 110 keeps the map updated to reflect the current state of the worksite. By updating only the relevant cells and maintaining the result queue of modified cells, the processing unit 110 efficiently handles incremental updates to the map.

At 1002, a decision is made whether the result queue contains data. For example, the processing unit 110 can examine the result queue for cell offsets with associated terrain data and obstacles that were added to the result queue at 940 of the terrain detection process 900 shown in FIGS. 10A and 10B. If there is data, then flow of the method 1000 can proceed toward 1004. Otherwise, flow of the method 1000 can terminate (e.g., and the while loop in the method 600 shown in FIG. 6 can proceed) or proceed to another operation.

At 1004, the data contained within the result queue is added to an internal grid. For example, the processing unit 110 can add this data to a grid in which cell offsets are cumulatively added over time to create a larger map. If cell offset in the internal grid contains existing data and the result queue contains new data for that same cell offset, the processing unit 110 replaces the existing data with the new data unless the new data is unstable and the existing data is stable.

Data may be unstable or stable based on movement or variations in movement of the asset 500 during collection of the data. For example, the roll, pitch, yaw, location along the x-axis or direction, location along the y-axis or direction, location along the z-axis or direction, velocity, etc. of the asset 500 may be measured by the movement sensor 160 during movement of the asset 500. The processing unit 110 can examine the roll, pitch, yaw, location along the x-axis or direction, location along the y-axis or direction, location along the z-axis or direction, and/or velocity to determine whether the data collected by the optical sensors 120, 130 during the movement of the asset 500 are stable or unstable data. The data may be identified as stable by the processing unit 110 if a moving average of the roll, pitch, yaw, location along the x-axis or direction, location along the y-axis or direction, location along the z-axis or direction, and/or velocity does not vary by more than a threshold amount, such as 0.1 degrees, 0.3%, 1.0%, etc., during the movement of the asset 500.

At 1006, the updated cells of the internal grid are added to an internal cell queue. The internal cell queue is a data structure within or accessible to the processing unit 110 that temporarily holds references to grid cells in the terrain map that have been recently updated or modified. After the result queue is processed and the internal grid is updated with new or revised terrain and obstacle data, the specific cells that have changed data are added to the internal cell queue. The internal cell queue allows the processing unit 110 to efficiently manage and track which cells need to be further processed, communicated, or included in updates to the map. For example, the internal cell queue can be used to assemble a terrain state message or to trigger updates in the user interface or external map processes. The processing unit 110 avoids unnecessary processing of data for the entire grid and ensures that only the most current and relevant information is propagated through the machine guidance system 100 by maintaining the internal cell queue of only cells affected by new sensor data.

FIG. 12 illustrates a flowchart of one example of the map update process 1100. The processing unit 110 can perform the operations of the map update process 1100. At 1102, a decision is made whether the internal cell queue contains data. The processing unit 110 can examine this queue to determine whether any data has been updated for one or more than one cells, such as the updated cells that were added to the internal cell queue at 1006 of the internal grid update process 1000 shown in FIG. 11. If there is such data, flow of the method 1100 proceeds toward 1104. At 1104, the updated cells in the internal cell queue are used to create a terrain state message. The terrain state message is a data packet or structured communication generated by the processing unit 110 to represent the current condition of specific portions of the terrain map. The terrain state message includes updated information about the state of selected grid cells. This information can include the elevation, the calculated grade, the presence of obstacles, or other relevant terrain features. This information is determined or calculated by the processing unit 110 and/or sensor suite based on the recent sensor data and internal processing. The terrain state message can be created from the internal cell queue, which holds references to grid cells that have been recently updated. The message combines recent values for these cells and groups the values into a format for transmission to other components, such as the map process, guidance algorithms, or operator interface. The terrain state message can be used by the processing unit 110 to communicate only the changed or relevant portions of the terrain map, rather than the entire map. The processing unit 110 uses this message to keep the operator, autonomous control logic, and any external monitoring or logging systems informed about the current terrain conditions.

If there is no such data at 1102, then the method 1100 may terminate or return to another operation. At 1106, a terrain state message is sent to the map process to update the map grid. At 1108, the internal cell queue is cleared. For example, the processing unit 110 can delete or otherwise discard the data in the internal cell queue.

### VI. Vehicle Observer Process

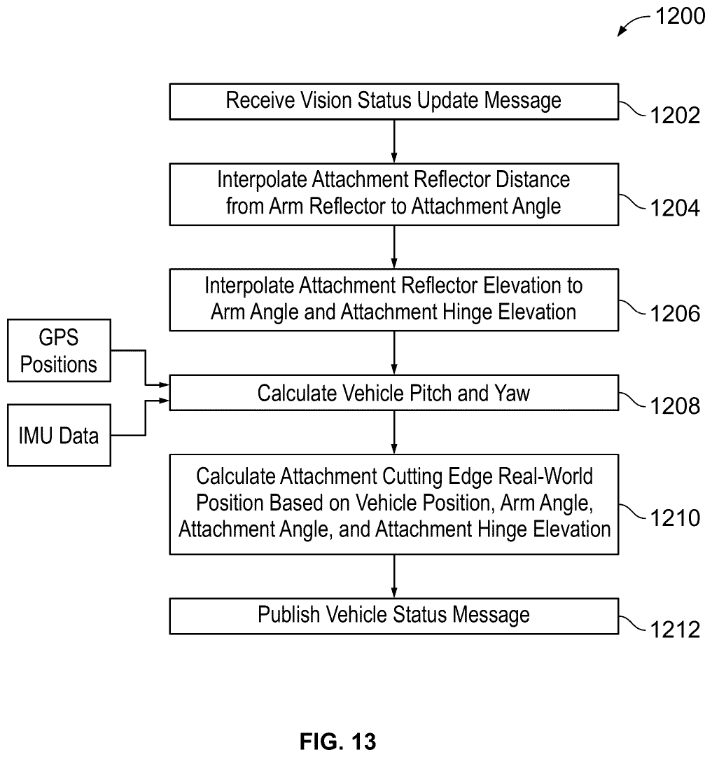

FIG. 13 illustrates a flowchart of one example of a vehicle observer process 1200. The observer process 1200 in some embodiments is referred to as an asset observer process, and can represent the operations performed by the processing unit 110. At 1202, a vision status update message is received. This message can be the vision status update message published at 848 of the arm/attachment detection process 800 shown in FIG. 8.

At 1204, the distance of the attachment reflector 544 from the arm reflector 546 in the XZ plane (which is calculated at 846 of the arm/attachment detection process 800 shown in FIG. 8) is interpolated to the attachment angle. In some examples, data is gathered manually during a calibration process in which the attachment angle is varied throughout the feasible range and, for each attachment angle, a user or the processing unit 110 measures the attachment angle with an inclinometer and measures the distance between the centroids of the attachment reflector 544 and arm reflector 546 in the XZ plane. The data is then interpolated by applying the NumPy interpolation function (numpy.interp), which allows a query of the attachment angle for any given distance measurement. In some embodiments, other methods may be used to determine the attachment angle in accordance with the inventive subject matter, including a NumPy polynomial fit (numpy.polyfit).

At 1206, the elevation of the attachment reflector 544 (which is the z-value of the attachment centroid calculated at 844 of the arm/attachment detection process 800 shown in FIG. 8) is interpolated to the arm angle and the elevation of the attachment hinge. In some examples, data is gathered manually during a calibration process in which a temporary calibration reflector is placed on the attachment hinge in a location that can be seen by the front optical sensor 120 to enable a calculation of the (x, y, z) values of the centroid of a temporary calibration reflector.

The temporary calibration reflector is a reflective marker or device that is temporarily attached to a specific location on the asset 500 or the asset attachment. This location can be an attachment hinge of the attachment or the cutting edge of the bucket. The reflector is attached during the calibration of the machine guidance system 100. The optical sensor 120 and/or 130 detects the temporary reflector in point cloud data, allowing the processing unit 110 to determine the (x, y, z) coordinates of the temporary reflector. As the asset 500 or attachment moves through a range of motion, the processing unit 110 records the position of the temporary calibration reflector at various angles or positions. Once calibration is complete and the necessary data has been collected, the temporary calibration reflector can be removed from the asset 500 or attachment.

The arm angle is then varied throughout the feasible range and, for each or several arm angles, a user or the processing unit 110 measures the arm angle with an inclinometer, measures the elevation of the centroid of the attachment reflector 544, and measures the elevation of the centroid of the temporary calibration reflector. The data is then interpolated by applying the NumPy interpolation function, which allows a query of the arm angle and attachment hinge elevation for any given attachment reflector elevation. Of course, other methods may be used to determine the arm angle and attachment hinge elevation in accordance with the inventive subject matter, including a NumPy polynomial fit.

At 1208, the pitch and yaw of the asset 500 are calculated as a function of the positions of the front and rear GNSS antennas 145, 155, which are obtained from the GNSS receivers 140, 150. In some examples, the pitch calculation is further based on the arm angle (which was determined at 1206) and the roll angle of the asset 500 (which is obtained from the IMU data provided by the movement sensor 160).

In some examples (such as those relating to a radial lift track loader), the pitch calculation is performed by the processing unit 110 using a vector-based approach in which the calculations are based solely on the positions of the GNSS antennas 145, 155. With this approach, the position of the front GNSS antenna 145 and the position of the rear GNSS antenna 155 may be expressed as follows:

$${P}_{f ront} = ( {x}_{front} , {y}_{f ront} , {z}_{f ront} ) π \qquad ( 1 )$$

$${P}_{rear} = ( {x}_{r ear} , {y}_{r ear} , {z}_{r e a r} ) \qquad ( 2 )$$

The vector between the front and rear GNSS antennas 145, 155 may be expressed as follows:

$$V = {P}_{front} - {P}_{rear} = ( {x}_{front} - {x}_{rear} , {y}_{front} - {y}_{rear} , {z}_{front} - {z}_{rear} ) \qquad ( 3 )$$

The distances between the front and rear GNSS antennas 145, 155 along the x-axis, y-axis, and z-axis may be expressed as follows:

$$Vx = {x}_{f ront} - {x}_{rear} \qquad ( 4 )$$

$$Vy = {y}_{front} - {y}_{rear} \qquad ( 5 )$$

$$Vz = {z}_{front} - {z}_{rear} \qquad ( 6 )$$

The horizontal distance between the front and rear GNSS antennas 145, 155 may be expressed as follows:

$$Vh = \sqrt{{Vx}^{2} + {Vy}^{2}} \qquad ( 7 )$$

The pitch angle (θ) may then be expressed as follows:

$$θ = arctan ( \frac{Vz}{Vh} ) \qquad ( 8 )$$

Substituting equations (4) to (7) into equation (8), the pitch angle (θ) may be rewritten as follows:

$$θ = arctan ( \frac{{z}_{front} - {z}_{rear}}{\sqrt{{( {x}_{front} - {x}_{rear} )}^{2} + {( {y}_{front} - {y}_{rear} )}^{2}}} ) \qquad ( 9 )$$

In some examples (such as those relating to a vertical lift track loader), the pitch calculation is performed by the processing unit 110 using polynomials to compensate for GNSS motion. This motion may be the movement or displacement of the GNSS antennas 145, 155, such as changes in the positions of the GNSS antennas 145, 155 due to movement of the arm or other components of the asset 500 (e.g., a rear linkage of the arm).

With this approach, the calculations are based on the positions of the front and rear GNSS antennas 145, 155, as well as the arm angle and the roll angle of the asset 500. These calculations reference the parameters summarized in Table 1 below:

TABLE 1

| | |
|---|---|
| x_{front}, y_{front}, z_{front} | offsets for the front GNSS antenna 145 in the |
| | vehicle coordinate frame |
| xᵣₑₐᵣ, yᵣₑₐᵣ, zᵣₑₐᵣ | offsets for the rear GNSS antenna 155 in the |
| | vehicle coordinate frame |
| A | arm angle |
| D | distance between the front and rear GNSS antennas |
| | 145, 155 |
| a₀, a₁, a₂, a₃ | polynomial coefficients for the rear GNSS antenna |
| | 155 offset as a function of the arm angle |
| z_{f} | elevation of the front GNSS antenna 145 in the |
| | NED coordinate frame |
| zᵣ | elevation of the rear GNSS antenna 155 in the NED |
| | coordinate frame |
| ϕ | roll angle of the asset |
| z_{f, rel} | elevation of the front GNSS antenna 145 relative to |
| | the vehicle reference position |
| z_{r, rel} | elevation of the rear GNSS antenna 155 relative to |
| | the vehicle reference position |
| x_{f, proj} | projected offset for the front GNSS antenna 145 |
| | considering the roll angle |
| x_{r, proj} | projected offset for the rear GNSS antenna 155 |
| | considering the roll angle |
| b₀, b₁, b₂, b₃, b₄ | polynomial coefficients for the pitch calculation |
| | based on measured data |
| θ_{GPS} | pitch angle in degrees calculated from GNSS data |
| θ_{obs} | final observed pitch angle after polynomial |
| | adjustment |

First, the offset of the rear GNSS antenna 155 may be expressed as a function of the arm angle, as follows:

$${x}_{rear} = {x}_{rear} ( {a}_{0} + {a}_{1} α + {a}_{2} {α}^{2} + {a}_{3} {α}^{3} ) \qquad ( 10 )$$

The distance between the front and rear GNSS antennas 145, 155 may be calculated as follows:

$$d = \sqrt{{( {x}_{front} - {x}_{rear} )}^{2} + {( {y}_{front} - {y}_{rear} )}^{2} {( {z}_{front} - {z}_{rear} )}^{2}} \qquad ( 11 )$$

The elevations of each of the front and rear GNSS antennas 145, 155 may be expressed as follows:

$${z}_{f} = {z}_{front} \qquad ( 12 )$$

$${z}_{r} = {z}_{rear} \qquad ( 13 )$$

The elevations of each of the front and rear GNSS antennas 145, 155 relative to the centroid of the asset 500 may be calculated as follows:

$${z}_{f , rel} = {z}_{f} - {z}_{front} \qquad ( 14 )$$

$${z}_{r , rel} = {z}_{r} - {z}_{rear} \qquad ( 15 )$$

The projected offsets for the front and rear GNSS antennas 145, 155 considering the roll angle may be calculated as follows:

$${x}_{f , proj} = cos ( ϕ ) {gx}_{front} + sin ( ϕ ) {gy}_{front} \qquad ( 16 )$$

$${x}_{r , proj} = cos ( ϕ ) {gx}_{rear} + sin ( ϕ ) {gy}_{rear} \qquad ( 17 )$$

The pitch angle may be calculated from the GNSS data as follows:

$${θ}_{GPS} = arctan 2 ( {z}_{f , rel} - {z}_{r , rel} , d - tan ( ϕ ) g {(}_{{X}_{f , proj}} - x {r}_{, proj} ) ) \qquad ( 18 )$$

The pitch angle may then be adjusted using a polynomial fit, as follows:

$${θ}_{obs} = {b}_{0} + {b}_{1} {θ}_{GPS} + {b}_{2} {θ}_{GPS}^{2} + {b}_{3} {θ}_{GPS}^{3} + {b}_{4} {θ}_{GPS}^{4} \qquad ( 19 )$$

It should be understood that either of the above approaches may be used to calculate the pitch of the asset 500. Of course, other pitch calculation approaches may be used in accordance with the inventive subject matter.

The yaw of the asset 500 may be calculated from the positions of the front and rear GNSS antennas 145, 155. The differences in the north and east positions may be expressed as follows:

$$Δ N = {N}_{f ront} - {N}_{r e a r} \qquad ( 20 )$$

$$Δ E = {E}_{front} - {E}_{r e a r} \qquad ( 21 )$$

The bearing between the two points, which represents the heading of the asset 500, may be calculated as follows:

$${θ}_{r a d} = - arctan 2 ( Δ E , VN ) \qquad ( 22 )$$

$${θ}_{deg} = {θ}_{ra d} \times \frac{180}{π} \qquad ( 23 )$$

Finally, the yaw angle is adjusted to ensure it lies within the range [−180°, 180° ], as follows:

$$θ = \{ \begin{matrix}{θ}_{deg} + 360 & if {θ}_{deg} \leq - 180 \\ {θ}_{deg} - 360 & if {θ}_{deg} > 180 \\ {θ}_{deg} & otherwise\end{matrix} \qquad ( 24 )$$

Other yaw calculation approaches may be used in accordance with the inventive subject matter.

Referring the method 1200 shown in FIG. 13, at 1210, the real-world position of the cutting edge of the attachment 514 can be calculated based on the position of the asset 500 (determined at 1208), the attachment angle (determined at 1204), and the arm angle and attachment hinge elevation (determined at 1206). In some examples, data is gathered manually during a calibration process in which a temporary calibration reflector is placed on the cutting edge of the attachment 514 in a location that can be seen by the front optical sensor 120 to calculate the (x, y, z) values of the centroid of the temporary calibration reflector. The attachment angle can be varied throughout the feasible range and, for each attachment angle, the attachment angle is measured with an inclinometer and the elevation of the centroid of the temporary calibration reflector is calculated or measured. The elevation of the centroid of the temporary calibration reflector is calculated by the processing unit 110 determining the Z-coordinate of the centroid of the reflector's detected points in the sensor coordinate system, and then transforming that value into the desired reference frame (such as the vehicle coordinate frame). For example, the front optical sensor 120 may detect one hundred data points from the reflector. After filtering, the average Z-value of the filtered points (in the vehicle frame) may be 2.35 meters. The elevation of the centroid is calculated by the processing unit 100 to be 2.35 meters above the reference plane (e.g., ground or vehicle base).

The data is then interpolated by applying the NumPy interpolation function, which allows a query of the attachment cutting edge elevation for any given attachment angle. Of course, other methods may be used to determine the attachment cutting edge elevation in accordance with the inventive subject matter, including a NumPy polynomial fit. The attachment cutting edge elevation is then combined with the attachment hinge elevation (determined at 1206) to provide a local attachment cutting edge elevation. At 1212, the elevation of the cutting edge of the attachment 514 is set on the vehicle status message and published for use by the map process and the navigation process.

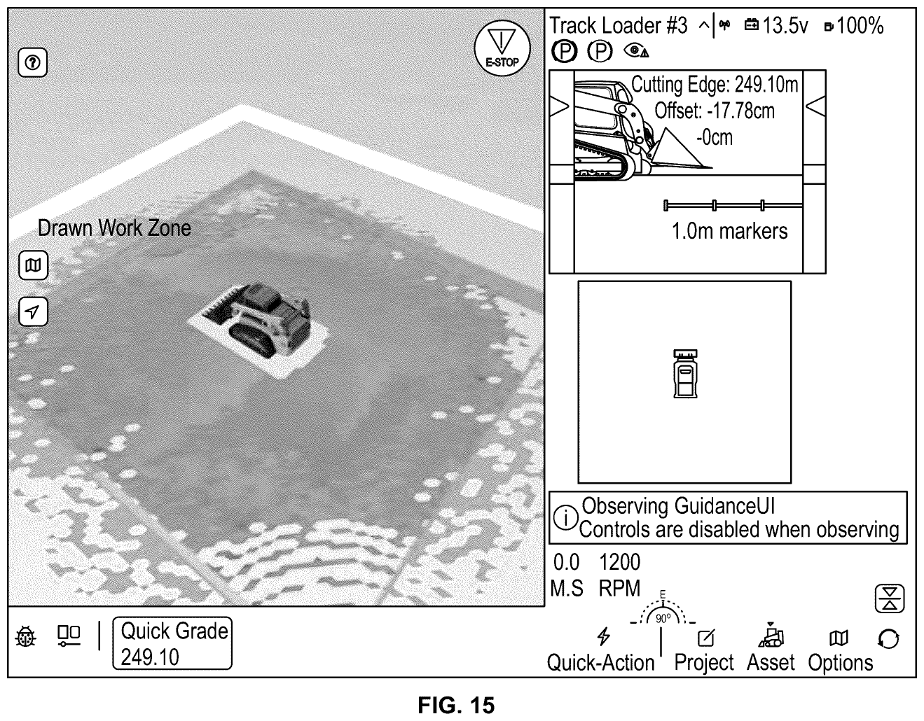

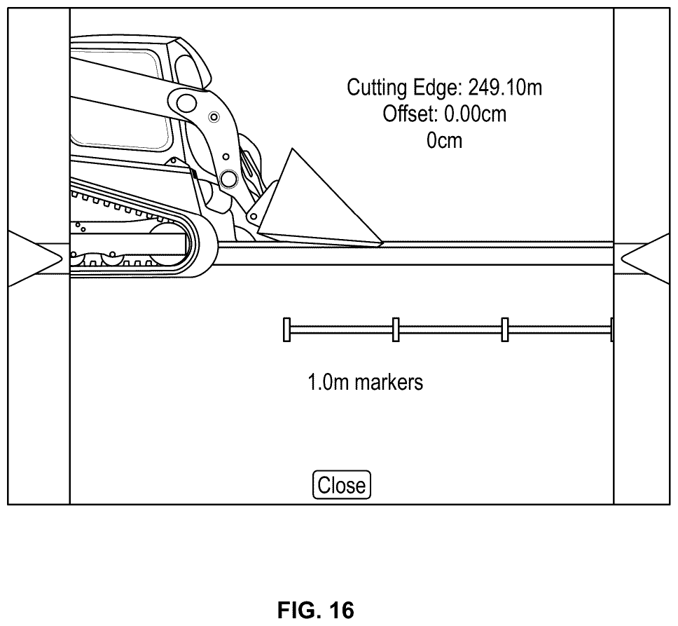

FIGS. 14 through 16 include example screen shots of a guidance application showing various map views during the operation of the asset 500. The data obtained and the information calculated from this data as described herein is used to show the asset 500 and/or attachment 514 relative to real-world objects in the map. These screen shots may be presented on the computing device 175 or another output device. FIG. 14 shows a top view of the asset and surrounding terrain, along with a side view showing the elevation of the cutting edge of the attachment 514 in relation to the elevation of the surrounding terrain. FIG. 15 shows a perspective view of the asset 500 and surrounding terrain, along with a side view showing the elevation of the cutting edge of the attachment 514 in relation to the elevation of the surrounding terrain. FIG. 16 is an enlarged side view showing the elevation of the cutting edge of the attachment 514 in relation to the elevation of the surrounding terrain. In these map views, the data is visualized in a color gradient from red-green-blue so that the terrain that is above grade is shown in red, the terrain that is on grade is shown in green, and the terrain that is below grade is shown in blue. Thus, the operator is able to quickly view the current elevation profile of the terrain in a large area around the asset without getting out of the asset.

In some examples, the machine guidance system 100 may also be used to track other equipment at the work site. For example, a construction vehicle with the integrated machine guidance system 100 could be parked near a secondary piece of equipment on which one or more than one reflector 544, 546 is placed, which enables the machine guidance system 100 to track that secondary piece of equipment in accurate real-world coordinates.

The processing unit 110 autonomously controls the asset to perform autonomous excavation by integrating real-time sensor data, terrain mapping, and control algorithms to execute excavation tasks with minimal or no operator intervention. The processing unit 110 receives point cloud data from the optical sensors 120, 130 and position and orientation data from the GNSS antennas 145, 155 and GNSS receivers 140, 150, as well as the movement sensor 160. The processing unit 110 generates a real-time 3D terrain map of the worksite. This map can identify the current surface profile, slopes, and obstacles (such as rocks, equipment, or personnel) in an excavation area.

The processing unit 110 can calculate or be provided with desired excavation parameters, such as the target depth, slope, or grade of an excavation to be completed. The processing unit 110 plans the excavation based on these parameters. For example, the processing unit 110 can divide the work area into manageable sections and generate an optimal path and sequence for the attachments (e.g., bucket or blade) of the asset 500 to follow.

Using forward kinematics and calibration data, the processing unit 110 calculates the precise position and orientation of the cutting edge of the attachment 514 in real time. The processing unit 110 continuously or repeatedly compares the current position of the attachment 514 to the planned excavation path and target grade. The processing unit 110 sends control signals to the actuators (e.g., hydraulic cylinders, motors) of the asset 500 to adjust the position, angle, and depth of the attachment 514. The processing unit 110 incrementally lowers or moves the attachment 514 (or directs the ACU 180 to lower or move the attachment 514) to remove material in controlled layers.

If the asset 500 encounters harder material or increased resistance during excavation or grading, the processing unit 110 can autonomously adjust the depth of cut or modify the excavation strategy. For example, the processing unit 110 can reduce the depth at which the cutting edge of the attachment 514 is moved to during each of several iterations or passages of the attachment 514 through dirt, earth, or other materials being excavated. The processing unit 110 continuously or repeatedly monitors feedback from the sensors 120, 130, 160, GNSS antennas 145, 155, and/or GNSS receivers 140, 150 to detect deviations from the plan, unexpected obstacles, or changes in terrain. If an obstacle is detected or the terrain changes, the processing unit 110 recalculates the excavation path or temporarily halts movement to avoid collisions or unsafe conditions. The processing unit 110 can also dynamically update the terrain map as material is removed, ensuring that the excavation remains accurate and efficient.

The processing unit 110 enforces operational limits, such as maximum depth, slope, or speed, to prevent unsafe movements. If a sensor error, actuator fault, or unexpected condition is detected, the processing unit 110 can autonomously stop the excavation, alert the operator, or switch to a safe mode.

As one example, an operator or the processing unit 110 can move the asset 500 to an initial, starting, or first location. This location may be where the dirt, earth, or other materials are to be excavated. This location can be referred to as an excavation location. The operator or the processing unit 110 can note or record this location using the GNSS antennas 145, 155 and the GNSS receivers 140, 150. The operator or the processing unit 110 can then move the asset 500 to a final, ending, or second location. This location may be where the dirt, earth, or other materials excavated at the excavation location are dumped or piled. This location can be referred to as the pile location. The operator or the processing unit 110 can note or record this location using the GNSS antennas 145, 155 and the GNSS receivers 140, 150. In some embodiments, the pile location can be recorded or identified before the excavation location.

The processing unit 110 may then automatically control the asset 500 (or direct the ACU 180 to control the asset 500) to move to the excavation location. During movement toward the excavation location, the processing unit 110 collects data from the sensors 120, 130, 160, GNSS antennas 145, 155, and/or GNSS receivers 140, 150, analyzes the data as described herein to identify obstacles in or near the path of the asset 500 (e.g., within a threshold distance of the asset 500), such as one meter) and/or steep changes in terrain along or near the path of the asset 500. The steep changes can be a change in grade in the terrain of at least ±5%, at least ±10%, or at least another grade change. The processing unit 110 can control (or direct the ACU 180) to control the asset 500 and the attachment 514 to prevent colliding with the detected obstacles and to avoid steep changes in terrain (e.g., to prevent tipping over or moving into a hole). Once the asset 500 reaches the excavation location, the processing unit 110 controls (or directs the ACU 180 to control) the asset 500 to lower the cutting edge of the attachment 514 to the desired or directed depth to excavate dirt or other material from the excavation location. The processing unit 110 then controls the asset 500 to move toward the pile location.

During movement toward the pile location, the processing unit 110 collects data from the sensors 120, 130, 160, GNSS antennas 145, 155, and/or GNSS receivers 140, 150, analyzes the data as described herein to identify obstacles in or near the path of the asset 500, and/or steep changes in terrain along or near the path of the asset 500. The processing unit 110 can control (or direct the ACU 180) to control the asset 500 and the attachment 514 to prevent colliding with the detected obstacles and to avoid steep changes in terrain. Once the asset 500 reaches the pile location, the processing unit 110 controls (or directs the ACU 180 to control) the asset 500 to tilt and/or lower the attachment 514 to dump the dirt or materials carried by the attachment 514 from the excavation location at the dump location.

The path between the excavation location and the pile location need not be previously planned for the asset 500. For example, the processing unit 110 may only receive the excavation location and the pile location as path-defining inputs and autonomously control (or direct the ACU 180 to autonomously control) movement of the asset 500 between these locations. As point cloud data is received, the processing unit 110 can identify terrain features and obstacles as the movement of the asset 500 is autonomously controlled, and the locations of these identified features and obstacles are automatically avoided by the processing unit 110 and/or ACU 180. No path connecting the locations needs to be predefined or calculated by the processing unit 110. The processing unit 110 can analyze the point cloud data as the asset 500 is moving to determine when and where the asset 500 can and should move, without planning the entire path ahead of time.

As the asset 500 digs at the excavation location and dumps at the pile location, the processing unit 110 continues to obtain updated sensor data at these locations. This keeps the processing unit 110 updated with the size of the excavation and of the pile. The processing unit 110 can move the asset 500 according to this updated information, such as by moving the asset 500 and the attachment 514 to an edge of the excavation for continued digging (instead of the middle of the excavation location) and to an edge of the pile (instead of the middle of the pile location). This can prevent the asset 500 from tipping or being stuck in the excavation or on the pile.

As the asset 500 moves between the excavation location and the pile location, the processing unit 110 repeatedly receives and analyzes the data from the sensor suite of the machine guidance system 100 (e.g., the sensors 120, 130, 160, GNSS antennas 145, 155, and/or GNSS receivers 140, 150) to detect both permanent and transitory obstacles. A permanent obstacle is an object or feature within the construction site environment that remains in a fixed location and is expected to persist throughout the duration of the project or a significant portion of the project. Examples of permanent obstacles include buildings, retaining walls, utility poles, large boulders, or other infrastructure elements that are not intended to be moved or altered during normal operations. These obstacles are typically incorporated into the site's digital terrain map and are used by the processing unit 110 for long-term path planning, excavation boundaries, and safety zones. A transitory obstacle, on the other hand, is an object or feature that is temporary, movable, or only present for a short period of time. Transitory obstacles include construction equipment, vehicles, personnel, debris, or materials that may be relocated or removed as work progresses. These obstacles can appear and disappear unpredictably and may change position frequently. The processing unit 110 detects these transitory obstacles in real time using sensor data from the sensor suite, and dynamically adjusts or stops the movement of the asset 500 to avoid collisions and ensure safety.

One or more examples of the processes and methods described herein include a method that includes receiving point cloud data from one or more than one optical sensor mounted on a construction asset having a machine guidance system. The point cloud data can represent portions of terrain and obstacles outside of the asset. The method also can include filtering the point cloud data that is received based on one or more than one predetermined thresholds and applying one or more spatial filters to isolate features of the terrain from the point cloud data that is filtered, processing the point cloud data that is filtered to identify terrain features and obstacles, autonomously controlling movement of the asset and an attachment to the asset while performing one or both of excavation or material dumping at a worksite using the terrain features and the obstacles that are identified, receiving position data and movement data from one or more than one position or movement sensor mounted to the asset, fusing the point cloud data that is filtered, the position data, and the movement data to calculate a real-world position, orientation, and a calculated position of a cutting edge of the attachment, and autonomously controlling the asset to adjust the position and the orientation of the attachment to maintain the calculated position of the cutting edge of the attachment at a target grade during at least some of the movement of the asset that is autonomously controlled.

The method also can include calculating an estimated elevation of the cutting edge of the attachment relative to a ground surface using the calculated position of the cutting edge and comparing the estimated elevation with a target grade to determine a deviation. Autonomously controlling the asset to adjust the position and the orientation of the attachment to maintain the calculated position of the cutting edge at the target grade can be performed using the deviation.

The method also can include receiving an excavation location and a pile location, where the movement of the asset can be autonomously controlled between the excavation location and the pile location and the point cloud data that is filtered is processed to identify the terrain features and the obstacles while the asset is moving between the excavation location and the pile location. The movement of the asset can be autonomously controlled between the excavation location and the pile location without a previously defined path being received, calculated, or obtained.

Filtering the point cloud data can include removing data points associated with a reflectivity value that is below a predetermined threshold and applying one or more than one box filter to isolate the data points associated with the terrain features from the data points associated with the asset.

The method also can include generating a terrain map of an area surrounding the asset using the point cloud data that is filtered, the position data, and the movement data that is fused. Generating the terrain map can include dividing the area surrounding the construction asset into a grid of cells, and for each of the cells, calculating an elevation value based on elevations of data points in the point cloud data that are projected into that cell.

The method also can include updating only the cells in the grid of the terrain map that correspond to locations with newly received or modified point cloud data.

One or more examples of the machine guidance systems described herein include a machine guidance system comprising one or more than one optical sensor mounted on an asset. The one or more than one optical sensor can sense an area around the asset and outputting point cloud data representative of portions of terrain and obstacles outside of the asset. The machine guidance system can include one or more than one position sensor mounted on the asset that can output position data indicative of geographic positions of the one or more than one position sensor, a movement sensor mounted on the asset and configured to output movement data indicative of movement of the movement sensor, and a processing unit that can receive and filter the point cloud data that is received based on one or more predetermined thresholds and by applying one or more spatial filters to isolate features of the terrain from the point cloud data that is filtered. The processing unit can examine the point cloud data that is filtered to identify terrain features and obstacles and autonomously controlling movement of the asset and an attachment to the asset using the terrain features and the obstacles that are identified. The processing unit can fuse the point cloud data that is filtered, the position data, and the movement data to calculate a real-world position, orientation, and a calculated position of a cutting edge of an attachment to the asset. The processing unit can autonomously control the asset to adjust the position and the orientation of the attachment to maintain the calculated position of a cutting edge of the attachment at a target grade during at least some of the movement of the asset that is autonomously controlled.

The processing unit can calculate an estimated elevation of the cutting edge of the attachment relative to a ground surface using the calculated position of the cutting edge and comparing the estimated elevation with a target grade to determine a deviation. The processing unit can autonomously control the asset to adjust the position and the orientation of the attachment to maintain the calculated position of the cutting edge at the target grade using the deviation.

The processing unit can receive an excavation location and a pile location, and the processing unit can autonomously control the movement of the asset between the excavation location and the pile location. The processing unit can identify the terrain features and the obstacles from the point cloud data that is filtered while the asset is moving between the excavation location and the pile location.

The processing unit can autonomously control the movement of the asset between the excavation location and the pile location without a previously defined path being received, calculated, or obtained. The processing unit can filter the point cloud data by removing data points associated with a reflectivity value that is below a predetermined threshold and by applying one or more than one box filter to isolate the data points associated with the terrain features from the data points associated with the asset.

The processing unit can generate a terrain map of an area surrounding the asset using the point cloud data that is filtered, the position data, and the movement data that is fused. The processing unit can generate the terrain map by dividing the area surrounding the construction asset into a grid of cells, and for each of the cells, calculating an elevation value based on elevations of data points in the point cloud data that are projected into that cell. The processing unit can update only the cells in the grid of the terrain map that correspond to locations with newly received or modified point cloud data.

One or more of the processes and methods described herein include a method that can include identifying an excavation location where a construction asset is to excavate material using an attachment to the asset, identifying a pile location where the construction asset is to pile the material that is excavated, obtaining point cloud data from light detection and ranging (LiDAR) sensors onboard the asset, processing the point cloud data to identify terrain features and obstacles outside of the asset, and to calculate a position of a cutting edge of the attachment, and autonomously controlling the asset to excavate the material at the excavation location using the position of the cutting edge of the attachment that is calculated, to move the asset to the pile location without colliding with the obstacles and without a previously defined or calculated path between the excavation location and the pile location being obtained, and to dump the material at the pile location using the point cloud data.

The point cloud data can be obtained by the LiDAR sensors measuring reflection off reflective surfaces on the asset and the attachment. The point cloud data can be processed to identify the terrain features and the obstacles by applying one or more than one box filter associated with the asset and with the attachment to the point cloud data. The method also can include receiving position data from one or more than one global navigation satellite system (GNSS) receivers onboard the asset, receiving movement data from an inertial measurement unit (IMU) onboard the asset, and generating a terrain map of an area surrounding the asset by fusing the point cloud data, the position data, and the movement data.

References to “one embodiment,” “an embodiment,” “an example embodiment,” or “embodiments” mean that the feature or features being described are included in at least one embodiment of a machine guidance system deployed on a construction vehicle. Separate references to “one embodiment, “an embodiment, “an example embodiment,” or “embodiments” in this disclosure do not necessarily refer to the same embodiment and are also not mutually exclusive unless so stated and/or except as will be readily apparent to one of ordinary skill in the art from the disclosure. For example, a feature, structure, function, etc. described in one embodiment may also be included in other embodiments, but is not necessarily included. Thus, a machine guidance system or method can include a variety of combinations and/or integrations of the features, structures, functions, etc. described herein.

In this disclosure, the use of any and all examples or exemplary language (such as “for example”) is intended merely to better describe the embodiments and does not pose a limitation on the scope of all embodiments of the inventive subject matter. No language in the disclosure should be construed as indicating any non-claimed element essential to the practice of the inventive subject matter.

Also, the use of the terms “comprises,” “comprising,” or any other variation thereof, are intended to cover a non-exclusive inclusion, such that a system, device, or method that comprises a list of elements does not include only those elements, but may include other elements not expressly listed or inherent to such system, device, or method.

Further, the use of relative relational terms, such as first and second, are used solely to distinguish one unit or action from another unit or action without necessarily requiring or implying any actual such relationship or order between such units or actions.

Finally, while the inventive subject matter has been described and illustrated hereinabove with reference to various example embodiments, it should be understood that various modifications could be made to these embodiments without departing from the scope of the invention. Therefore, the inventive subject matter is not to be limited to the specific structural configurations or methodologies of the example embodiments, except insofar as such limitations are included in the following claims.

What is claimed is:

1. A method comprising:
receiving point cloud data from one or more than one optical sensor mounted on a construction asset having a machine guidance system, the point cloud data representing portions of terrain and obstacles outside of the asset;
filtering the point cloud data that is received based on one or more than one predetermined thresholds and applying one or more spatial filters to isolate features of the terrain from the point cloud data that is filtered;
processing the point cloud data that is filtered to identify terrain features and obstacles;
autonomously controlling movement of the asset and an attachment to the asset while performing one or both of excavation or material dumping at a worksite using the terrain features and the obstacles that are identified;
receiving position data and movement data from one or more than one position or movement sensor mounted to the asset;
fusing the point cloud data that is filtered, the position data, and the movement data to calculate a real-world position, orientation, and a calculated position of a cutting edge of the attachment; and
autonomously controlling the asset to adjust the position and the orientation of the attachment to maintain the calculated position of the cutting edge of the attachment at a target grade during at least some of the movement of the asset that is autonomously controlled.

2. The method of claim 1, further comprising:
calculating an estimated elevation of the cutting edge of the attachment relative to a ground surface using the calculated position of the cutting edge and comparing the estimated elevation with a target grade to determine a deviation,
wherein autonomously controlling the asset to adjust the position and the orientation of the attachment to maintain the calculated position of the cutting edge at the target grade is performed using the deviation.

3. The method of claim 1, further comprising:
receiving an excavation location and a pile location,
wherein the movement of the asset is autonomously controlled between the excavation location and the pile location and the point cloud data that is filtered is processed to identify the terrain features and the obstacles while the asset is moving between the excavation location and the pile location.

4. The method of claim 3, wherein the movement of the asset is autonomously controlled between the excavation location and the pile location without a previously defined path being received, calculated, or obtained.

5. The method of claim 1, wherein filtering the point cloud data includes removing data points associated with a reflectivity value that is below a predetermined threshold and applying one or more than one box filter to isolate the data points associated with the terrain features from the data points associated with the asset.

6. The method of claim 1, further comprising:
generating a terrain map of an area surrounding the asset using the point cloud data that is filtered, the position data, and the movement data that is fused.

7. The method of claim 6, wherein generating the terrain map comprises dividing the area surrounding the construction asset into a grid of cells, and for each of the cells, calculating an elevation value based on elevations of data points in the point cloud data that are projected into that cell.

8. The method of claim 7, further comprising:
updating only the cells in the grid of the terrain map that correspond to locations with newly received or modified point cloud data.

9. A machine guidance system comprising:
one or more than one optical sensor mounted on an asset, the one or more than one optical sensor sensing an area around the asset and outputting point cloud data representative of portions of terrain and obstacles outside of the asset;
one or more than one position sensor mounted on the asset and configured to output position data indicative of geographic positions of the one or more than one position sensor;
a movement sensor mounted on the asset and configured to output movement data indicative of movement of the movement sensor; and
a processing unit configured to receive and filter the point cloud data that is received based on one or more predetermined thresholds and by applying one or more spatial filters to isolate features of the terrain from the point cloud data that is filtered, the processing unit examining the point cloud data that is filtered to identify terrain features and obstacles and autonomously controlling movement of the asset and an attachment to the asset using the terrain features and the obstacles that are identified, the processing unit configured to fuse the point cloud data that is filtered, the position data, and the movement data to calculate a real-world position, orientation, and a calculated position of a cutting edge of an attachment to the asset, the processing unit configured to autonomously control the asset to adjust the position and the orientation of the attachment to maintain the calculated position of a cutting edge of the attachment at a target grade during at least some of the movement of the asset that is autonomously controlled.

10. The machine guidance system of claim 9, wherein the processing unit is configured to calculate an estimated elevation of the cutting edge of the attachment relative to a ground surface using the calculated position of the cutting edge and comparing the estimated elevation with a target grade to determine a deviation,
wherein the processing unit is configured to autonomously control the asset to adjust the position and the orientation of the attachment to maintain the calculated position of the cutting edge at the target grade using the deviation.

11. The machine guidance system of claim 9, wherein the processing unit is configured to receive an excavation location and a pile location, and the processing unit is configured to autonomously control the movement of the asset between the excavation location and the pile location and the processing unit is configured to identify the terrain features and the obstacles from the point cloud data that is filtered while the asset is moving between the excavation location and the pile location.

12. The machine guidance system of claim 11, wherein the processing unit autonomously controls the movement of the asset between the excavation location and the pile location without a previously defined path being received, calculated, or obtained.

13. The machine guidance system of claim 9, wherein the processing unit is configured to filter the point cloud data by removing data points associated with a reflectivity value that is below a predetermined threshold and by applying one or more than one box filter to isolate the data points associated with the terrain features from the data points associated with the asset.

14. The machine guidance system of claim 9, wherein the processing unit is configured to generate a terrain map of an area surrounding the asset using the point cloud data that is filtered, the position data, and the movement data that is fused.

15. The machine guidance system of claim 14, wherein the processing unit is configured to generate the terrain map by dividing the area surrounding the construction asset into a grid of cells, and for each of the cells, calculating an elevation value based on elevations of data points in the point cloud data that are projected into that cell.

16. The machine guidance system of claim 15, wherein the processing unit updates only the cells in the grid of the terrain map that correspond to locations with newly received or modified point cloud data.

17. A method comprising:
identifying an excavation location where a construction asset is to excavate material using an attachment to the asset;
identifying a pile location where the construction asset is to pile the material that is excavated;
obtaining point cloud data from light detection and ranging (LiDAR) sensors onboard the asset;
processing the point cloud data to identify terrain features and obstacles outside of the asset, and to calculate a position of a cutting edge of the attachment; and
autonomously controlling the asset to excavate the material at the excavation location using the position of the cutting edge of the attachment that is calculated, to move the asset to the pile location without colliding with the obstacles and without a previously defined or calculated path between the excavation location and the pile location being obtained, and to dump the material at the pile location using the point cloud data.

18. The method of claim 17, wherein the point cloud data is obtained by the LiDAR sensors measuring reflection off reflective surfaces on the asset and the attachment.

19. The method of claim 17, wherein the point cloud data is processed to identify the terrain features and the obstacles by applying one or more than one box filter associated with the asset and with the attachment to the point cloud data.

20. The method of claim 17, further comprising:
receiving position data from one or more than one global navigation satellite system (GNSS) receivers onboard the asset;
receiving movement data from an inertial measurement unit (IMU) onboard the asset; and
generating a terrain map of an area surrounding the asset by fusing the point cloud data, the position data, and the movement data.
